(19) United States
(12) Patent Application Publication
(10) Pub. No.: US 2005/0086035 A1
(43) Pub. Date: Apr. 21, 2005

(54) Computer systems and methods for genotype to phenotype mapping using molecular network models

(75) Inventors: Jean M. Peccoud, Des Moines, IA (US); Kent A. Vander Velden, Perry, IA (US)

Correspondence Address: PIONEER HI-BRED INTERNATIONAL INC., 7100 N.W. 62ND AVENUE, P.O. BOX 1000, JOHNSTON, IA, 50131, US

(73) Assignee: Pioneer Hi-Bred International, Inc.

(21) Appl. No.: 10/931,862

(22) Filed: Sep. 1, 2004

Related U.S. Application Data
(60) Provisional application No. 60/499,955, filed on Sep. 2, 2003.
(60) Provisional application No. 60/499,786, filed on Sep. 2, 2003.

(51) Int. Cl. G06F 17/10

(52) U.S. Cl. 703/2

(57) ABSTRACT

A computer system and methods are provided for mapping genotypes to phenotypes. The system includes a molecular network model and an optimizer. Functions of the molecular network model called trait functions are implemented to compute simulated phenotypes of the network. Simulated phenotypes are numerical properties of the molecular network that correspond to observed phenotypes which are observable properties of the biological system represented by the molecular network model. The optimizer optimizes the network to fit simulated phenotypes to observed phenotypes. The genotype to phenotype mapping system is useful in prediction of phenotypes, identification of phenotypic differences among polymorphic genotypes, determination of environmental effects on phenotypic development, determination of differences in patient response to a therapeutic agent due to genetic polymorphism, and genetic engineering of a target phenotype. Also provided are computer program products implementing the disclosed computer systems, computer data structures representing genotypic and phenotypic data, and computer readable media capable of storing such data structures.

### CROSS-REFERENCE TO RELATED APPLICATIONS

This application claims priority to and benefit of U.S. Provisional Application No. 60/499,955, filed Sep. 2, 2003 and U.S. Provisional Application No. 60/499,786 filed Sep. 2, 2003, each of which are incorporated by reference herein.

### BACKGROUND OF THE DISCLOSURE

1. Field of the Disclosure

The present disclosure relates in general to molecular network models. Specifically, the present disclosure provides computer systems and methods for molecular network modeling or simulation of biological processes in a living system. Qualitative as well as quantitative representation of macromolecules and their interactions is enabled. More specifically, the computer systems of this disclosure are capable of deriving genotype to phenotype maps based on molecular network models. Trait functions are provided in various embodiments, representing simulated phenotypes of the network. The system enables network optimization to match simulated phenotypes to experimentally observed phenotypes. The genotype to phenotype maps may be used in predicting phenotypes, identifying phenotypic differences among polymorphic genotypes, and genetic engineering of desirable phenotypes, among other things. The disclosed computer systems can therefore be advantageously applied in plant breeding, drug discovery, pharmacogenomics, and individualized medicine.

2. Description of the Related Art

The discovery of DNA double helix structure over a half century ago sprouted decades of growth of molecular biology that continues with some momentum today. New understandings of biomolecules, biological processes, and living systems at the molecular level supplements the knowledge of classic biology, botany, zoology, microbiology, physiology, and genetics. Genotypic analyses based on genomes of various species parallels studies of phenotypic observations via experimental models of animals, plants, and microbes. Most recently, researchers welcomed the dawn of a new era of molecular biology upon the completion of sequencing of human genome and the genomes of several other species—an era that emphasizes the dimension of genomics and proteomics. Whether an older generation biologist, a dyed-in-wool geneticist, or a seasoned molecular biologist, scientists desire the convergence of the macroscopic and microscopic views of living systems. Such convergence would enhance comprehensive understanding of the mechanism of life, and thereby point to promising avenues for the discovery of new diagnostics and therapeutics and the betterment of agricultural and other bioengineering products.

The challenge of bridging molecular biology—as well as genomics or proteomics—and the older sciences of biology, medicine, and genetics is however nontrivial. The classic Mendelian model for determining phenotypes from genotypes, for example, focuses on the abstract concepts of segregating loci, alleles, traits, and environment. Whereas, in a molecular genetics context, the concrete physical manifestation of genes in DNA chains casts a different dimension for studying the expression and regulation of genes and the interactions of gene products. The processes by which phenotypes are developed from genotypes may be summarily tracked with the Central Principle of “DNA-RNA-Protein” in molecular biology. There is a lack of systematic approaches for relating such molecular biology concepts to the macroscopic notion of phenotype, genotype, and environment upon which the science of genetics has been built.

Also worth noting, the merge of mathematics, computer sciences, and biomedical sciences in the recent decade has availed information technologies and theoretical mathematics frameworks to the resolution of many biomedical, genetic, and bio-agricultural problems. Advances in genomics, proteomics, and bioinformatics evidence such an emerging trend. Modeling has been adopted as an effective approach to decompose, construct, and simulate biological processes and systems.

In the realm of quantitative genetics, linear modeling has been applied to determine correspondence between genotype and phenotype variations. See, Kempthorne, 1988, An Overview of the Field of Quantitative Genetics, Proceedings of the Second International Conference on Quantitative Genetic. Statistics is used in that context to allow the development of validated models for phenotypic expression from incomplete information on genotypes and environmental factors. See, id. Although linear statistical models allow geneticists to decipher—whether qualitatively or quantitatively—the genetic architecture of a large number of simple traits, those models cannot account for the nonlinear gene to gene interactions. As appreciated by a skilled geneticists or molecular biologist, interactions between genes contribute to complex phenotypes in a manifold of species, including microbes, mice, and plants. See, e.g., Elena and Lenski, 2001, Evolution, (55): 1746-1752; Steinmetz et al., 2002, Nature, (416): 326-330; Leamy et al., 2002, Evolution, (56): 642-653; Eshed and Zamir, 1996, Genetics, (143): 1807-1817; Li et al., 2001, Genetics (158): 1737-1753. In general, non-linear effects of gene interactions are referred to collectively as epistatic effects. See, Rutherford, 2000, Bioessays, (22): 1095-1105. There is a general lack of success in modeling non-linear properties of gene interactions. Introduction of non-linear terms in the studies of gene interactions and the resulting phenotypes leads to considerable theoretical difficulties that prevent closed-form expression of model properties. See supra, Kempthorne.

A disconnect is conspicuous between the kind of modeling exercises in classic quantitative genetics and the modern simulation studies based on gene network models. The former elucidates genotype and phenotype relations in terms of classic genetic concepts whereas the latter focuses on the kinetics of molecular interactions among genes and the proteins they encode.

The field of gene network modeling is one that turns on as much mathematical and engineering considerations as the knowledge of genes and gene products in a specific biological system or process. For example, simulation of biochemical reactions in a metabolic pathway may be performed using a network model that is properly constructed, validated, and optimized, based on the existing biological understanding of the pathway and available experimental observations. Similarly, simulation of stimulatory as well as inhibitory events in a regulatory pathway may be performed using a network model that is built and validated based on the cumulative understanding afforded by experimental biology. Interactions between DNA, RNA, proteins, and other molecules in a living system are captured in such networks. Therefore, a more appropriate term-as what is used throughout the present disclosure-may be coined for this field: molecular network modeling, as opposed to gene network modeling.

Various mathematic formalisms have been utilized in representing molecular components of a network and their interactions. Examples include Bayesian networks, differential equations, directed graphs, stochastic networks, and rule-based systems, among other things. See, in general, De Jong, 2002, Modeling and Simulation of Genetic Regulatory Systems: a Literature Review. For a given biological process or living system of interest, the approximation provided by different mathematic representations may differ, due to applicable qualitative or quantitative considerations. For example, depending on the structural, functional, or behavioral aspects of the biological processes and systems being modeled, a mathematic representation may be discrete or continuous; static or dynamic; and deterministic, stochastic, or Boolean. See, id.

Species whose biology has been understood better make better objects for molecular network modeling. The EcoCyc Database project is an example of pathway modeling that captured a substantially complete set of metabolic reactions in E. coli, although not all that is known. See, Karp, et al., 2002, The EcoCyc Database, Nucleic Acids Research 30(1): 56-8. This E. coli pathway model concerns metabolism of E. coli, with a focus on the kinetics of individual biochemical reactions, as a rich pool of experimental data is available on kinetics of E. coli reactions. Rule-based formalism is used to simulate the firing of cascade reactions. See, e.g., Karp, et al., 2002, The Pathway Tools Software, Bioinformatics (18): S225-32.

Similar efforts in the research community and commercial world have been on going in simulating biological processes or biological systems with various mathematic formalisms. Diverse in both the complexity of bioprocesses being modeled and the mathematic representations used, some efforts focus on interactions of two or more proteins whereas others engage in the modeling of system behavior of a cell, organ, or organism—a supposed object of system biology. See, e.g., www.myriad-proteomics.com; www.systemsbiology.org. See also, Kanehisa et al., 2002, The KEGG Databases at GenomeNet, Nucleic Acids Res. Vol. 30, no. 1 p. 42-46; Mikulecky, 1990, Modeling Intestinal Absorption and Other Nutrition-Related Processes Using PSPICE and STELLA, J. of Ped. Gastroenterology and Nutrition, (11): 7-20; Erdi and Toth, 1989, Mathematical Models of the Chemical Reaction, 1^{st} ed. Manchester: Manchester University Press; Peccoud and Ycart, 1995, Markovian Modeling of Gene Product Synthesis, Theoretical Population Biology (48): 222-234; Oppenheim et al., Stochastic and Deterministic Formulation of Chemical Rate Equations, J. of Chemical Physics, (50): 460-466. However, none of the existing work has offered a systemic approach for tracking phenotypic changes from genotypic variations based on a molecular network model that approximates both qualitative state information and quantitative dynamics features of a biological process or a biological system.

There is therefore a need for a new modeling methodology or simulation paradigm that supports the integrated analyses of biological systems and processes that, albeit draws from the knowledge domain of molecular biology, genomics, and proteomics, remains in line with the conceptual and experimental framework of age-old sciences of biology and genetics. Particularly, there is a need for determining and validating correspondence between genotypes at the molecular or genomic level on the one hand and phenotypes in terms of classic genetics on the other, by modeling and simulating molecules and their interactions within a biological process and system. To that end, there is a related need to bridge kinetic characteristics of a network and its time-independent traits captured in network dynamics or network topology. There is a further need to account for environmental factors in the modeling of molecular networks in addition to the factors or molecules intrinsic to the network.

### SUMMARY OF THE VARIOUS EMBODIMENTS

It is therefore an object of this disclosure to provide a computer system for mapping genotypes to phenotypes using molecular network models. The system includes a molecular network model, a user interface to collect inputs from the user and display the output, and an optimizer comprising a parameter optimization loop and the molecular network model (See FIG. 19). The molecular network model of this computer system enables qualitative and quantitative representation of various molecules and their interactions. The computer system also provides for the evaluation of effects of environmental factors on genotype-to-phenotype mapping. It may be used for predicting phenotypes, identifying phenotypic differences among polymorphic genotypes, determining environmental effects on phenotypic development of a genotype, determining differences in patient response to a therapeutic agent due to genetic polymorphism, and genetic engineering of a target phenotype. The computer system according to this disclosure thus may be advantageously applied in plant or crop breeding, drug discovery, pharmacogenomics and individualized medicine, among other things. Computer programs and program products are also disclosed which implement the disclosed computer system.

The computer system of the present disclosure supports the methods for mapping genotypes to phenotypes using a molecular network model. Such methods are disclosed in U.S. Provisional Application No. 60/499,955, filed Sep. 2, 2003, entitled “Genotype to Phenotype Mapping Based on Molecular Network Models.” This provisional application is hereby incorporated by reference in its entirety. Methods are also disclosed in this related application for using the genotype to phenotype mapping in prediction of phenotypes, identification of phenotypic differences among polymorphic genotypes, determination of environmental effects on phenotypic development of a genotype, determining differences in patient response to a therapeutic agent due to genetic polymorphism, and genetic engineering of a target phenotype.

In accordance with the present disclosure, there is provided, in one embodiment, a computer system capable of deriving a genotype to phenotype map. The genotype to phenotype map comprises a multiplicity of relations between one or more genotypes and one or more phenotypes. The computer system comprises: (a) a molecular network model comprising at least one mathematical representation of interactions of a plurality of molecules, wherein one or more discrete parameter values are assigned to parameterized genetic loci based on allelic polymorphism, wherein one or more combinations of environmental variables time courses define an environment, wherein one or more phenotypes are identified as observable properties of the molecular network model that can be related to experimental observations, under a multiplicity of conditions, of the living system being represented by the model; (b) a user interface capable of presenting the molecular network model and accepting user input; and (c) an optimizer capable of executing an optimization strategy for obtaining a minimum of the distance between the observed phenotypes and the corresponding simulated phenotypes of the molecular network model thereby deriving the genotype to phenotype map, the simulated phenotypes being capable of being represented by a trait function of the molecular network model under said multiplicity of conditions

In one embodiment, the trait function derives the simulated phenotype by integrating a simulated trajectory of the molecular network model. In another embodiment, the trait function derives the simulated phenotype by taking one or more steady-state values of at least one of the state variables of the molecular network model. In yet another embodiment, the trait function derives the simulated phenotype by calculating the time required for at least one of the state variables to reach a predetermined value. In still another embodiment, the trait function derives the simulated phenotype by taking the variance of time series of at least one of the state variables.

In a further embodiment, the trait function derives the simulated phenotype by (i) summing the values of a first plurality of the state variables thereby deriving a first sum, (ii) summing the values of a second plurality of the state variables thereby deriving a second sum, and (iii) dividing the first sum by the second sum. In a still further embodiment, the first plurality of state variables represents at least two enzymes, and the second plurality of state variables represents at least two transcription factors.

In another embodiment, the trait function derives the simulated phenotype by taking a Boolean value based on the one or more state variables.

In yet another embodiment, the state variables of the mathematical representation are one of continuous, discrete, Boolean, and any combination thereof. In still another embodiment, the mathematical representation is dynamic. In a further embodiment, the time evolution of the mathematical representation is one of deterministic, stochastic, and any combination thereof. In a still further embodiment, the time evolution of the mathematical representation comprises at least one of differential equations, stochastic processes such as a jump process, a Poisson process, a diffusion process. In another embodiment, the time evolution of the mathematical representation is at least one of homogeneous in time or non-homogeneous in time.

In another embodiment, the optimization strategy comprises at least one of a local area optimization method, a global search method, and any combination thereof. In yet another embodiment, the local area optimization method is one of the Newton method, simplex method, the gradient descent method. In still another embodiment, the global search method is one of genetic algorithm, differential evolution, simulated annealing, shifting search strategy, and random search.

In a further embodiment, the optimization strategy applies at least one of linear programming and non-linear programming. In still a further embodiment, the linear and non-linear programming is through at least one of deterministic and stochastic methods. In another embodiment, the deterministic and stochastic methods are constrained or unconstrained.

In still another embodiment, the molecular network model comprises a state space representing one or more molecule species. The state space comprises one or more dimensions; each dimension of the state space comprises at least one of a variable and an environmental variable. The variable represents one of the molecular species. The environmental variable represents an environmental factor capable of altering the time evolution of the variables associated with molecular species.

In a further embodiment, the environmental factor is a biotic environmental factor, representing a biological factor. In a still further embodiment, the biotic environmental factor is one of the insect pressure, virus pressure, fungus pressure and the disease pressure. In another embodiment, the environmental factor is an abiotic environmental factor, representing a non-biological factor. In yet another embodiment, the abiotic environmental factor is selected from the group consisting of temperature, light, pressure, pH, osmotic pressure, water availability, hormones, and chemical signals.

In a still further embodiment, the target phenotype comprises at least one of a native trait and non-native trait.

In another embodiment, experimental data is derived by the experimentation from the group consisting of genomes, transcriptomes, proteomes, and metabolomes. Each of the genomes comprises a multiplicity of genes belonging to a species. Each of the transcriptomes comprises RNAs transcribed from a multiplicity of genes that populate a genome. Each of the proteomes comprises a multiplicity of proteins translated from a multiplicity of RNAs that populate a transcriptome. Each of the metabolomes comprises a multiplicity of metabolic reactions among a multitude of biomolecules in the metabolism of a species.

In still another embodiment, the species is selected from the group consisting of bacteria, viruses, yeast, mammal, and crop plants. In a further embodiment, the crop plants are selected from the group consisting of soybean, maize, canola, sorghum, wheat, rice, alfalfa, and canola. In still a further embodiment, the mammal is a human.

In another embodiment, the experimental data is expression profile data, comprising levels of RNAs of a multiplicity of genes belonging to one or more species. In yet another embodiment, the expression profile data further comprises levels of proteins encoded by the multiplicity of genes belonging to one or more species. In still another embodiment, the expression profile data is generated using micro arrays. In a further embodiment, the expression profile is generated by observing the activity of a reporter gene. In a further embodiment, the experimental data is generated using at least one of nucleotide and protein chips. In yet another embodiment, the experimental data are metabolite concentrations quantified by metabolic profiling technologies.

In still a further embodiment, the target phenotype is expressed in at least one of a prokaryote and a eukaryote. In another embodiment, the prokaryote is a bacterium or virus. In yet another embodiment, the eukaryote is selected from the group consisting of yeast, mammal, and crop plants. In still another embodiment, the mammal is a human. In a further embodiment, the crop plants are selected from the group consisting of soybean, maize, canola, sorghum, wheat, rice, alfalfa, and canola.

In another embodiment, a fitness value of the simulated phenotype is determined, representing the likelihood that the simulated phenotype will be selected under an environmental condition. The fitness value may be derived from at least one trait value that is derived from at least one trait function.

In still another embodiment, the molecular network model further comprises one or more subnets. In a further embodiment, the subnets belong to a hierarchical order. In a still further embodiment, the hierarchical order comprises a multitude of hierarchies. In another embodiment, the hierarchies are recursively defined. In yet another embodiment, at least one of the subnets is linked directly into the molecular network model.

In a further embodiment, computing is distributed in the computer system among a master and one or more slaves. The master and slaves are connected via a network. In a still further embodiment, the computing is optimization or simulation. In various embodiments, the network is wired or wireless, the wired or wireless network is a local or wide area network. In another embodiment, the master is capable of (i) receiving data input from the user interface and distributing computing tasks to the one or more slaves, (ii) receiving intermediate computing results from the one or more slaves, (iii) compiling the intermediate computing results thereby deriving a final computing result, and (iv) sending the final computer result to the user interface for visualization by the user.

In accordance with the present disclosure, there is provided, in another embodiment, a computer readable medium. The computer readable medium has stored thereon the database of the computer system. The database stores the genotypic and phenotypic data.

In accordance with the present disclosure, there is provided, in yet another embodiment, a computer data structure. The computer data structure represents at least one of the genotypes and phenotypes in the molecular network model. The computer data structure may be stored in a computer readable medium.

In accordance with the present disclosure, there is provided, in still another embodiment, a genotype to phenotype map derived in the computer system. The genotype to phenotype map may be stored in a computer readable medium.

### BRIEF DESCRIPTION OF THE DRAWINGS

FIG. 1 is a screenshot of the user interface of the GP mapping system according to one embodiment, showing the top-level menu bar as well as four pull-down menus for certain major functions supported by the interface.

FIG. 2 is a screenshot of the user interface of the GP mapping system according to one embodiment, showing a pop-up menu in the canvas for introducing new objects, such as molecules, reactions, subnets, etc., in the model.

FIG. 3 includes screenshots of a molecular properties dialog box of the user interface according to one embodiment, showing the “Options,” “Constraints,” and “Optimization” panes for specifying properties of the molecules in the network and especially for network optimization.

FIG. 4 shows the dialog box for a “Mass Action Reaction” object in the user interface according to one embodiment, showing its “Options,” “Constraints,” and “Optimization” panes.

FIG. 5 includes screenshots of a simulation options dialog box of the user interface according to one embodiment, showing two pull-down lists that allows the user to specify the type of simulation operations (e.g., ordinary differential equations (ODE), Stochastic, Poisson Approximation, and Poisson Hybrid) and the trait functions associated to the model (e.g., Glu6p*Constant Glucose).

FIG. 6 is a screenshot of the user interface according to one embodiment, showing the simulation results of the model at the completion of a simulation. The value of the selected trait function and fitness value is displayed on the status bar at the bottom of the window.

FIG. 7 is a screenshot of the user interface according to one embodiment, showing a Collage View of a model trajectory for the time course of several state variables in separate plots, including several genes, inducers, and repressors.

FIG. 8 is a screenshot of the user interface according to one embodiment, showing a Single View of a model simulation. This is a stochastic simulation. Several variables are reported on the same plot.

FIG. 9 is a screenshot of the user interface according to one embodiment, showing a Phase Plane view of a model simulation. One state variable (Reporter) is expressed as a function of another state variable (Repressor1).

FIG. 10 is a screenshot of the user interface according to one embodiment, showing the time evolution of the statistical distributions of molecule numbers. The distribution mean values are displayed by the superimposed dark plot.

FIG. 11 is a screenshot of a dialog box of the user interface according to one embodiment, specifying the time evolution of environmental variables.

FIG. 12 shows a Vol'pert diagram visualization of a molecular network via the user interface according to one embodiment.

FIG. 13 shows a visualization of a molecular network via the user interface according to one embodiment. The network models a metabolic pathway that includes 484 molecules and 730 elementary reactions. Subnets are shown, with six hierarchical layers.

FIG. 14 is a screenshot of the user interface according to one embodiment, showing how a subnet is recursively defined.

FIG. 15 is a diagram depicting the distributed computation in the GP mapping system according to one embodiment.

FIG. 16 represents three plasmids of the Guet library that have been optimized to match the phenotypes observed by Guet.

FIG. 17 is the time evolution of the population average performance distribution for each of the experiments in Application 2.

FIG. 18 represents the evolution of allele frequencies under selection for the first experiment in Application 2.

FIG. 19 provides a schematic representation of the interactions between the elements of the invention.

### DETAILED DESCRIPTION OF THE VARIOUS EMBODIMENTS

Discussion of the Relevant Terms

The following disciplines, mathematics, statistics, computer sciences, artificial intelligence, physics, biology, chemistry, medicine, genetics, population genetics, quantitative genetics, agriculture, botany, plant breeding, molecular biology, biochemistry, and physiology are to be understood consistently with their typical meanings appreciated by the skilled artisan in the relevant art.

Genomics, as used herein, refers to studies of nucleic acid sequences and applications of such studies in biology and medicine. Proteomics refers to studies of protein sequences, conformation, structure, protein physical and chemical properties, and applications of such studies in biology and medicine. Cheminformatics refers to the convergence of biopharmaceutical chemistry and information sciences, namely, the application of information technologies in biopharmaceutical chemistry. Bioinformatics refers to the convergence of biomedical sciences and information sciences, namely, the application of information technologies in biomedical sciences. Phamacogenomics refers to the application of genomics in biopharmaceutical research, discovery, and product development. Computational biology is the discipline that applies computational theories and methodologies to the biology research. Comparative genomics refers to comparative studies of a multitude of genomes from two or more species. With respect to certain subject matters, the aforementioned disciplines may overlap as appreciated by an ordinary skilled scientist or engineer.

The following terms, gene, nucleic acid, nucleotide, DNA, RNA, protein, peptide, genetic locus, allele, genetic polymorphism, genotype, phenotype, transcription, translation, transcription factor, promoter, suppressor, metabolism, metabolite, prokaryotes, eukaryotes, bacteria, virus, yeast, mammal, plants, crop plants, plant breeding, crop breeding, as well as other relevant terms throughout the present disclosure, are to be understood consistently with their typical meanings established in the relevant art, i.e. the art of biology, medicine, agriculture, botany, genetics, quantitative genetics, molecular biology, biochemistry, physiology, genomics, pharmacogenomics, bioinformatics, computational biology, proteomics, and cheminfomatics.

Particularly, nucleic acid in this disclosure refers to deoxyribonucleotides (DNA) or ribonucleotides (RNA) and polymers thereof in either single or double stranded form. The term encompasses nucleic acids containing known nucleotide analogs or modified backbone residues or linkages, which are synthetic, naturally occurring, and non naturally occurring, which have similar binding properties as the reference nucleic acid, and which are metabolized in a manner similar to the reference nucleotides. Examples of such analogs include, without limitation, phosphorothioates, phosphoramidates, methyl phosphonates, chiral methyl phosphonates, 2 O methyl ribonucleotides, and peptide nucleic acids (PNAs).

The terms “polypeptide,” “peptide,” and “protein” are used interchangeably in this disclosure to refer to a polymer of amino acid residues. The terms also apply to amino acid polymers in which one or more amino acid residue is an artificial chemical mimetic of a corresponding naturally occurring amino acid. Polypeptide, as used in this disclosure, includes full-length, naturally occurring proteins as well as recombinantly or synthetically produced polypeptides that correspond to a full-length naturally occurring protein or to particular domains or portions of a naturally occurring protein. The term also encompasses mature proteins that have an added amino-terminal methionine to facilitate expression in prokaryotic cells.

Amino acid, as used in this disclosure, refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, carboxyglutamate, phosphoserine, and phosphotheorine. Amino acid analogs refer to compounds that have the same basic chemical structure as a naturally occurring amino acid, i.e., a carbon that is bound to a hydrogen, a carboxyl group, an amino group, and an R group (e.g., homoserine, norleucine, methionine sulfoxide, methionine methyl sulfonium). Such analogs have modified R groups (e.g., norleucine) or modified peptide backbones, but retain the same basic chemical structure as a naturally occurring amino acid.

Gene expression, or expression, refers to the transcription of DNA sequences, which encode certain proteins or regulatory functions, into RNA molecules. The expression level of a given gene refers to the amount of RNA transcribed therefrom measured on a relevant or absolute quantitative scale. The measurement can be, for example, an optic density value of a fluorescent or radioactive signal, on a blot or a micro array image. Gene expression profile, as used in this disclosure, refers to expression levels of RNAs transcribed from a plurality of genes. Genes of interest may be differentially expressed. Differential expression means that the expression levels of certain genes are different in different states, tissues, or types of cells, according to a predetermined standard. Such standard may be determined based on the context of the expression experiments, the biological properties of the genes under study, and/or certain statistical significance criteria.

Gene expression may be measured by micro array according to one embodiment. Micro array, array, slide, and chip, are used interchangeably in this disclosure. Micro array refers to nucleotide arrays or protein or peptide arrays that can be used to detect biomolecules. Various kinds of arrays are made in research and manufacturing facilities worldwide, some of which are available commercially. There are, for example, two main kinds of nucleotide arrays that differ in the manner in which the nucleic acid materials are placed onto the array substrate: spotted arrays and in situ synthesized arrays. One of the most widely used oligonucleotide arrays is GeneChip™ made by Affymetrix, Inc. The oligonucleotide probes that are 20- or 25-base long are synthesized in silico on the array substrate. These arrays tend to achieve high densities (e.g., more than 40,000 genes per cm²). The spotted arrays, on the other hand, tend to have lower densities, but the probes, typically partial cDNA molecules, usually are much longer than 20- or 25-mers. Pre-synthesized and amplified cDNA sequences are attached to the substrate of these kinds of arrays. Protein and peptide arrays also are known. See Zhu et al., Science 293:2101 (2001).

In certain embodiments of this disclosure, the term expression refers to the biosynthesis of a gene product, which also encompasses the process of translation. For example, in the case of a structural gene, expression involves transcription of the structural gene into mRNA and the translation of mRNA into one or more polypeptides.

Consistent with the established meanings in the art, the term genotype is used in this disclosure to refer to genetic basis of any phenotypic expression of a trait; a genotype is based on any sequence and structural characteristics of DNA chains that constitute genes with polymorphic types. Genotypes at the DNA molecule level give rise to phenotypes at the protein or RNA level. For example, DNA variants of a certain gene (various genotypes) may be transcribed into corresponding mRNA variants, which in turn can be translated into protein variants. Thus, genotypic features are reflected in phenotypic traits. In certain embodiments, phenotypes are used to refer to functional traits that can be only observed at one particular stage of development. For example, drought tolerance can be measured during germination, flowering, and at harvest time. These would be three different phenotypic traits. An observed phenotype refers to the experimental data collected by observation of a phenotypic trait on an individual with a specific genotype in a specific environmental condition. A simulated phenotype, as used in this disclosure, refers to a numerical value calculated by applying a trait function to the molecular network model. See infra, the detailed description on trait functions.

As understood by a skilled artisan, genetic polymorphism refers to multitudes of genotypes encoding a phenotypic trait. Polymorphism may lie in substitution, deletion, or insertion of one or more nucleic acid bases at a genetic locus in the DNA chain. It is not uncommon that the same phenotype is expressed notwithstanding such variance in the DNA chain. In certain situations, however, reversal, enhancement, elimination, or other changes in the phenotypic expression may result from genotypic variance. Genetic polymorphism may manifest in one allele that locates in an individual chromosome or in more than one alleles residing in paired chromosomes in certain high organisms. Throughout this disclosure, the terms genetic polymorphism, allelic polymorphism, and polymorphism are used interchangeably.

As used in this disclosure, the term native trait refers to any functional or structural characteristic of an organism that is genetically determined and that is not manipulated by genetic engineering using, for example, recombinant DNA techniques. See Sambrook et al., 2001 Molecular Cloning: A Laboratory Manual, 3^{rd} ed. vol. 1-3, Cold Spring Harbor Press. Genetic engineering, as used herein, refers to genetically manipulating one or more genes in an organism thereby altering the corresponding phenotypes. Molecular biology techniques enabling genetic engineering are known to those skilled in the art.

A non-native trait, on the other hand, refers to a trait that results from genetic engineering. As appreciated by an ordinarily skilled molecular biologist, a non-native trait may be established in an organism by inducing mutations in target genes of interest, by introducing foreign DNA in the genome, by knocking out a gene thereby disabling a regulatory pathway, among other things. According to the various embodiments, a phenotype may be both a native and a non-native trait. In the same vein, a genotype, as used in certain embodiments of this disclosure, may refer to an actual or hypothetical genotypic characteristic; it may be native or non-native.

Molecular network model is referred to interchangeably in this disclosure with molecular network, gene network, gene network model, gene network framework, gene network system, genetic regulatory system, pathway model, biopathway model, and biosystem model. These terms are used in various embodiments to describe network models, network frameworks, or networks that provide at least one mathematical representation of interactions among a multitude of molecules. DNA, RNA, proteins, and small molecules, among others, may be included in such molecular networks and molecular network models. Interactions among these molecules may be represented qualitatively or quantitatively according to various embodiments. Networks or network models that depict metabolic pathways or regulatory pathways are examples of molecular network models or molecular networks according to this disclosure. In certain embodiments, molecular network models include one or more sub networks, termed subnets. The subnets may be composite or hierarchical in alternative embodiments.

According to this disclosure, a genotype to phenotype map, or a GP map, captures a multiplicity of relations between one or more genotypes, one or more environments, and one or more phenotypes based on a molecular network model. A GP map relates a set of genotypes to their corresponding phenotypes. The genotypes and phenotypes may be native or non-native, actual or hypothetical, in various embodiments.

As used in this disclosure, a phenotype refers to a property of interest in the living system represented by a specific molecular network model. A phenotype may be native or non-native; it may be an observed phenotype or a target phenotype. According to one embodiment, a target phenotype may be developed through genetic engineering or, as in agricultural sciences, by plant breeding. In various embodiments, combinations of classic genetics and recombinant DNA technology may be applied to assemble a genotype allowing the observation of the target phenotype when organisms with the specified genotype are placed in a specific environment.

An environmental variable in a molecular network, as used herein, represents an environmental factor that may alter the behavior of the network model. An environmental variable may be biotic or abiotic. Examples of environmental variables includes, among other things, temperature, light, pressure, pH, osmotic pressure, chemical signals, insect pressure, and disease pressure.

The state space of a molecular network model, as used in this disclosure, refers to the molecule entities in the network model and their states. The state space thus comprises a set of variable and environmental variables of the molecular network model. Additional discussions are provided infra in the detailed description. The state space may have multiple dimensions. The number of dimensions equals the number of molecule species and environmental variables in the network model. Each dimension of the state space corresponds to a variable or an environmental variable.

The parameter space of a molecular network model, as used in this disclosure, refers to multiple genetic loci in the network. Each genetic locus may correspond to one dimension of the parameter space. One or more genetic loci may be polymorphic. Genetic polymorphism at a genetic locus gives rise to different values of the corresponding parameter. Additional details are provided infra in the detailed description.

Network topology, as used in this disclosure, refers to the qualitative or structural features of the network, such as stoichiometric coefficients in certain embodiments.

The following terms, integral, differential equations, trajectory, state space, state variables, parameter space, Boolean variable, stochastic process (such as a jump process, diffusion process or Poisson process, each of which may be or may not be homogeneous in time), optimization, search algorithm, kinetics, dynamics, linear programming, non-linear programming, as well as other relevant terms throughout the present disclosure, are to be understood consistently with their typical meanings established in the relevant art, i.e. the art of mathematics, statistics, computer sciences, artificial intelligence, physics, bioinformatics, computational biology, genomics, proteomics, pharmacogenomics, and cheminfomatics.

Certain publicly or commercially available gene network model or framework such as QU-GENE software and CVODE, Scamp/Jarnac, Gepasi, UltraSan or Mobius, may be used in connection with various embodiments of this disclosure. See, Micallef K P et al., (2001) Bioinformatics, 17: 194-195; Podlich D W and Cooper M. (1998) Bioinformatics, 14: 632-653; Cohen S D; Hindmarsh A C (1996) Computer in Physics 10: 138-143; Sauro H M, (1993) Comput. Appl. Biosci. Vol 9 No. 4: 441-450; Mendes P., (1993) Comput. Appl. Biosci., vol. 9, no. 5:563-571; Couvillon J. et al., (1991) IEEE Software, 8:69-80. The rationale and applications of these network models are understood and appreciated by those skilled in the relevant art, including, among others, quantitative geneticists and computational biologists.

The terms optimization strategy, optimization method, search strategy, search method, search routine, are used interchangeably in various embodiments of this disclosure. As understood and appreciated by the skilled artisan in mathematics, computer sciences, and bioinformatics, such optimization or search is useful to derive a minimal distance between the dynamics of a network and a network phenotype defined by experimental data, under a given condition. As such, optimization or search methods are useful to identify an optimal set of inter-related parameters or variables for a network model under a given condition, according to various embodiments of this disclosure.

Molecular Network Model of the GP Mapping System

The computer system according to this disclosure includes a molecular network model. The computer system derives genotype-to-phenotype maps by constructing, validating, and optimizing the molecular network model (hence the GP mapping system).

As discussed supra, molecular network models encompass one or more mathematical representation of biomolecules, such as DNA, RNA, proteins, and small molecules, and interactions thereof. Various mathematical formalisms may be applied. The molecular state-space of the network model is continuous in one embodiment, discrete in another. In yet other embodiments, the state space of the molecular network model may be discrete in part and continuous in part. The time-evolution of the molecular network model is stochastic, in another embodiment, deterministic in yet another embodiment. In still other embodiments, the time-evolution of the molecular network model is stochastic in part and deterministic in part. That is, interactions between certain molecules might be deterministic while other processes and reactions in the network are stochastically characterized.

As discussed supra, one or more mathematic formalism may be used, individually or in combination, to represent the various interactions and relations of the molecules in a biology system or process. The examples of suitable formalism according to the various embodiments of this disclosure include: differential equations, difference equations, and stochastic processes. The principles and applications of these formalisms are well established in mathematics and will be understood by skilled computational biologists. See supra, De Jong. With respect to the implementation of rule-based formalisms, expert system tools such as CLIPS (See, Giarratano and Riley, 1998, Expert Systems: Principles and Programming, 3^{rd} ed., Thomson Learning; See also the world wide web at ghg.net/clips/CLIPS.html) and Common LISP (See, Steele, 1990, Common Lisp the Language, 2^{nd} ed., Digital Press) may be used.

One example of a simple molecular network is composed of chemical equations. Molecular networks may be represented as set of coupled chemical reactions using chemical equations. Referring to Equation (1) below, the first reaction represents the inactivation of the gene gal4g by glucose, denoted as Glu. The second reaction represents the expression of the gene, i.e. the production of one protein molecule from the DNA molecule encoding the protein. This reaction entails both transcription and translation processes. The last reaction represents the spontaneous degradation of the protein Gal4p.

$$gal 4 g + Glu {{⇄}_{{k}_{2}}}^{{k}_{1}} gal 4 g X \\ gal 4 g {\to }^{{k}_{3}} gal 4 g + Gal 4 p \\ Gal 4 p {\to }^{{k}_{4}} ∅ \qquad ( 1 )$$

This type of notation gives rise to a matrix of molecular networks. The general form of a chemical equation is:

$${\sum }_{m = 1}^{M} {α}_{m , r} {X}_{m} -> {\sum }_{m = 1}^{M} {β}_{m , r} {X}_{m} ( r = 1 , 2 , K R ) \qquad ( 2 )$$

Equation (2) is defined by the two M×R matrices α and β, referred to as the reactant and product matrices, respectively, and a vector X representing each of the M molecule species in the system. Data structures used to manipulate molecular networks in software are usually derived from these two matrices. The difference β−α may be referred to as the stoichiometric matrix.

The use of chemical equations as such in modeling molecular networks differs from their use in a pure chemistry context. In chemistry, the mass and numbers of atoms on two sides of an equation must remain constant, as dictated by the law of atomic balance. In biology, however, the strict adherence to the law of atomic balance is impracticable as the number of atoms involved in any given bioprocess or biosystem is simply too great to tract. Chemical equations in this context are therefore used as a meta-language. Reactions defining creation or removal of molecules relevant to a given system are permitted. It is atom-free stoichiometry that governs in such scenarios. See supra, Erdi and Toth.

Differential equations may be used to represent molecular interactions in a network model. A set of ordinary differential equations may be derived to simulate kinetics of chemical reactions based on the mass action rate law. The law states that the rate of a reaction is proportional to the concentration of its reactants. The generic form of a reaction rate is provided in Equation (3).

$${v}_{r} = {k}_{r} {\prod }_{i = 1}^{M} {[ {X}_{i} ]}^{{α}_{i , r}} \qquad ( 3 )$$

The rate n of reaction r is the product of its reactant concentrations. The reactant matrix may be conveniently used as exponents to express these rates in a generic way. The reaction rate depends on reaction specific kinetic rate constant. The dimension of this constant depends on the order of the reaction:

$${\sum }_{i = 1}^{M} {α}_{i , r} .$$

The time-evolution of all state variables—which define various states of all the molecules involved—may thus be summarized by a set of ordinary differential equations. The net time evolution of a molecule concentration is the difference between the rates of all the reactions producing this molecule and the rates of all the reactions consuming the molecule. These rates also need to be adjusted by the stoichiometric coefficients.

$$\frac{ⅆ {X}_{i}}{ⅆ t} = {\sum }_{r}^{} {β}_{i , r} {v}_{r} - {\sum }_{r}^{} {α}_{i , r} {v}_{r} \\ = {\sum }_{r}^{} {γ}_{i , r} {v}_{r} \qquad ( 4 )$$

Ordinary differential equation provides a reasonable approximation of the dynamics of populations of molecules at the thermodynamic limit when the size of the populations is large. When modeling at the level of gene regulation where genes are typically in single copy numbers, however, ordinary differential equations may represent a poor approximation of the system dynamics. The use of stochastic equations may be better suited in modeling biosystems in which the number of interacting molecules is small. Principles and methodologies of stochastic modeling of chemical and biological reactions are well established. See, e.g., Bartholomay, 1958, Stochastic Models for Chemical Reactions: I, Theory of the Unimolecular Reaction Process, The Bulletin of Mathematical Biophysics (20): 175-190; Bartholomay, 1959, Stochastic Models for Chemical Reactions: II, The Unimolecular Rate Constant, The Bulletin of Mathematical Biophysics, (21): 363-373; McQuarrie, 1967, Stochastic Approach to Chemical Kinetics, J. of applied probability, (4): 413-418; Oppenheim, et al., 1969, Stochastic and Deterministic Formulation of Chemical Rate Equations, J. of Chemical Physics, (50): 460-466.

In stochastic modeling, Markov process may be used—as differential equations—to characterize chemical kinetics. The marginal intensity of a reaction is the stochastic equivalent of the deterministic reaction rate. This intensity specifies the average number of occurrences of a reaction by unit of time. See supra, Bartholomay 1958 & 1958, McQuarrie, and Oppenheim 1969. Because the stochastic intensity is based on actual molecule numbers and not molecule concentration, the variable volume is removed from the kinetic constant in this context. A pure jump process employing random variables may be used to represent network dynamics. See, e.g., Gillespie, 1976, A General Method for Numerically Simulating the Stochastic Time Evolution of Coupled Chemical Reactions, J. of Computational Physics, (22): 403-434; Gillespie, 1977, Exact Stochastic Simulation of Coupled Chemical Reactions, J. of Physical Chemistry, (81): 2340-2361. In such a jump process, the next reaction and destination of the next jump are randomly distributed. The instance of the next jump is exponentially distributed. The probability of each reaction depends on the weight of their intensity relative to the sum of the intensities of all reactions. See, id.

The stochastic approach reaches its limitation when, for example, the rate constant of one reaction is several orders of magnitude larger than the rate of the slowest reaction or one population of molecules is several orders of magnitude larger than the smallest population. Under those circumstances, the network dynamics becomes stiff and the cost of computing stochastic dynamics becomes prohibitively high.

Fast and reliable approximations of stochastic dynamics would therefore be useful. In one embodiment of this disclosure, the combined use of stochastic and deterministic approaches are adopted. For example, ordinary differential equations may be used for constructing a network model and stochastic simulation may be performed after the network dynamics appear reasonably accurate. This allows one to explore the effects of stochastic noise in the later stage while focusing initially on building the network model with deterministic methodologies. It should be noted that, counterintuitively, there is in general no one-to-one correspondence between equilibrium points of differential equations and extrema of stationary distributions of the corresponding stochastic process. See supra, Erdi and Toth. Similarly, the mean values of the variables of the stochastic process do not match the trajectories of the ordinary differential equations, although the differences may be small. See, McQuarrie, 1964, Kinetics of Small Systems II, The J. of Chemical Physics, (40): 2914-2921.

According to another embodiment of this disclosure, another stochastic approximation method may be used, in which the number of jumps occurring during a small time step are approximated by a Poisson distribution. This may significantly improve simulation speed. See, e.g., Aparicio and Solari, 2001, Population Dynamics: Poisson Approximation and Its Relation to the Langevin Process, Phys. Rev. Lett., (86) 18: 4183-4186. Another approximation method we could use is the “maximum time-step method” described in Puchalka, J. and Kierzek, A. M. (2004). Bridging the gap between stochastic and deterministic regimes in the kinetic simulations of the biochemical reaction networks. Biophys. J. 86, 1357-1372.

In yet another embodiment, a different approximation approach is used where a combined network model is constructed which includes at least a deterministic subnet and a stochastic subnet. That is, for example, the network may be partitioned, according to its state space (which is defined by the numbers of the interconnected molecule entities in the network), into three classes of variables whose dynamics are represented by a pure jump process, a diffusion process, and differential equations, respectively. This may result in a generalized Markov process. See, e.g., Gardiner, 1983, Handbook of Stochastic Methods for Physics, Chemistry, and the Natural Sciences, Springer-Verlag. Some a priori knowledge of the size of the populations of molecules corresponding to each dimension of the state space is necessary for building such hybrid models. Since this information is usually not available before the model is simulated, one may presume that all variables jump between discrete values and look for a way of approximating the time-evolution of each variable as simulation proceeds. This approach implements a dynamic partitioning of the state-space that does not rely on a prior knowledge of molecule numbers and reaction rates. Ultimately, different characteristic specifics in the biosystems and bioprocesses require different approximation schemes.

As discussed supra, Mendelian genetics deems phenotypic traits as determined entirely by individual genes and it supports the simple mapping between genotypes and phenotypes without regard to interactions between genes and much less the environmental factors. However, as appreciated by today's researchers, many traits are quantitative in nature and are influenced by the combined presence of specific alleles at multiple loci. Statistic and genetic network models may be used to assess additive and non-additive (dominance and epistasis) effects of genetic loci on specific traits. See, e.g., Falconer and MacKay, 1996, Quantitative Genetics, Longman Group Ltd., Harlow, U.K.; Omholt et al., 2000, Gene Regulatory Networks Generating the Phenomena of Additivity, Dominance and Epistasis, Genetics (155): 969-980; Bagheri-Chaichian, et al., 2002, Epistasis and the Kinetics of Phenotypic Robustness in Metabolic Pathways, Math. Biosci. (184): 27-51. Complex traits are also often dependent on the environment in which a genotype is expressed. However, as summarized in the background section, non-linear aspects of gene interactions and their effects on phenotype expression are typically difficult to track by model properties in a closed form.

In one embodiment, the molecular network model of this disclosure accounts for both internal (variables of molecular entities) and external (environmental variables) factors. A variable is typically related to a molecule species within the network. Exemplary variables include: genes, proteins (such as enzymes and transcription factors), metabolites, promoters, catalytic RNA, enhancers, and environmental conditions the time evolution of which is not affected by the evolution of variables representing molecular species. An environmental variable may be non-biological (abiotic) or biological (biotic). Examples of biotic environmental variables include, among other things, insect pressure (presence of one or more insect populations and the related toxic or other damaging effects the insect populations may cause), virus pressure (presence of one or more virus populations and the related viral substances), fungus pressure (presence of fungus and the related toxin and other damaging effects), and disease pressure (outbreak of infectious or other diseases, the presence of diseased state or abnormal physiological conditions). Examples of abiotic environmental variables include, among other things, temperature, light, pressure, pH, water supply, hormone, chemical signal. The use of environmental variables permits the network model to evaluate environmental effects on the phenotype. In certain embodiments, terms that reflect interactions between genotype and environmental factors are included in addition to terms that reflect gene-gene interactions to enable more sophisticated mappings between genotype and phenotype.

User Interface of the GP Mapping System

The computer system for genotype to phenotype mapping (the GP mapping system) includes a user interface that is capable of presenting the molecular network model for visualization by a user and accepting user input. The user interface in one embodiment is graphical. It may be implemented via a web browser or as a standalone program. Various graphical programming languages may be used as appreciated by a skilled computer engineer. The user interface is not only a visualizer, allowing visualization of the network, but also an editor, allowing the user to construct a network graphically and edit the topology and related properties of the network. The interface is capable of accepting user input via various messaging methods such as dialog boxes, buttons, and menus.

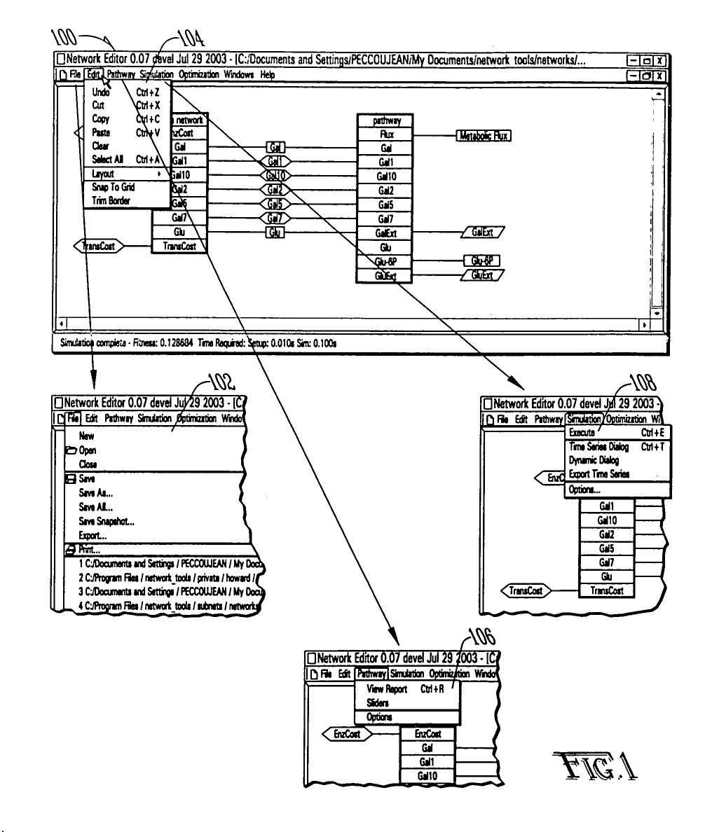

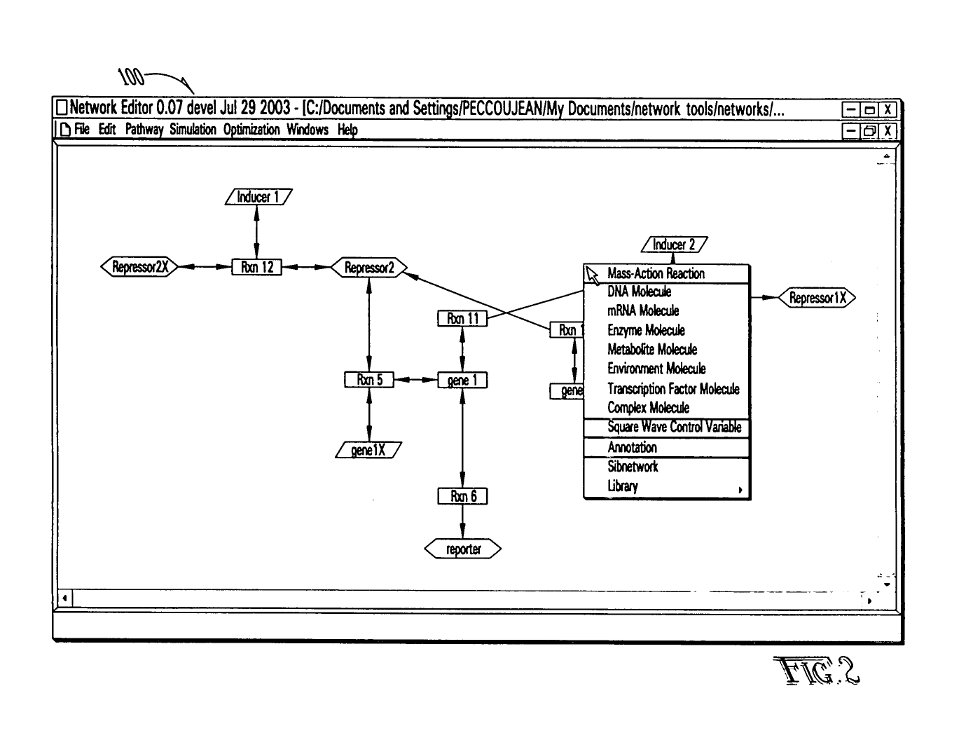

Referring to FIG. 1, the user interface, in one embodiment, provides a top-level menu bar 100, which includes menu items such as “File” (102), “Edit” (104), “Pathway” (106), and “Simulation” (108), among others. The menu item “File” (102) provides with the GP mapping system capacities of reading from and writing into a file or a database (See infra for the detailed discussion on the database of the system). Insertion of a subnet may also be provided from the pull-down “File” menu. The menu item “Edit’ (104) provides with the GP mapping system capacities of copying and pasting various graphical elements into the network, such as an activated gene, a transcription factor, and an enzyme. These operations are especially useful in the construction of a network from subnets, for example. The menu item “Pathway” (106) includes a number of options and optimization processes that may be invoked. Parameters may be adjusted from a pull-down menu here. Also provided are various reports on the network and the molecule entities involved. The menu item “Simulation” (108) allows display of simulation results such as time series. Such results may be analyzed using various plotting enabled in the user interface. The user may enter specific parameters for the simulation from Options dialog box that may be launched from the Simulation menu (108).

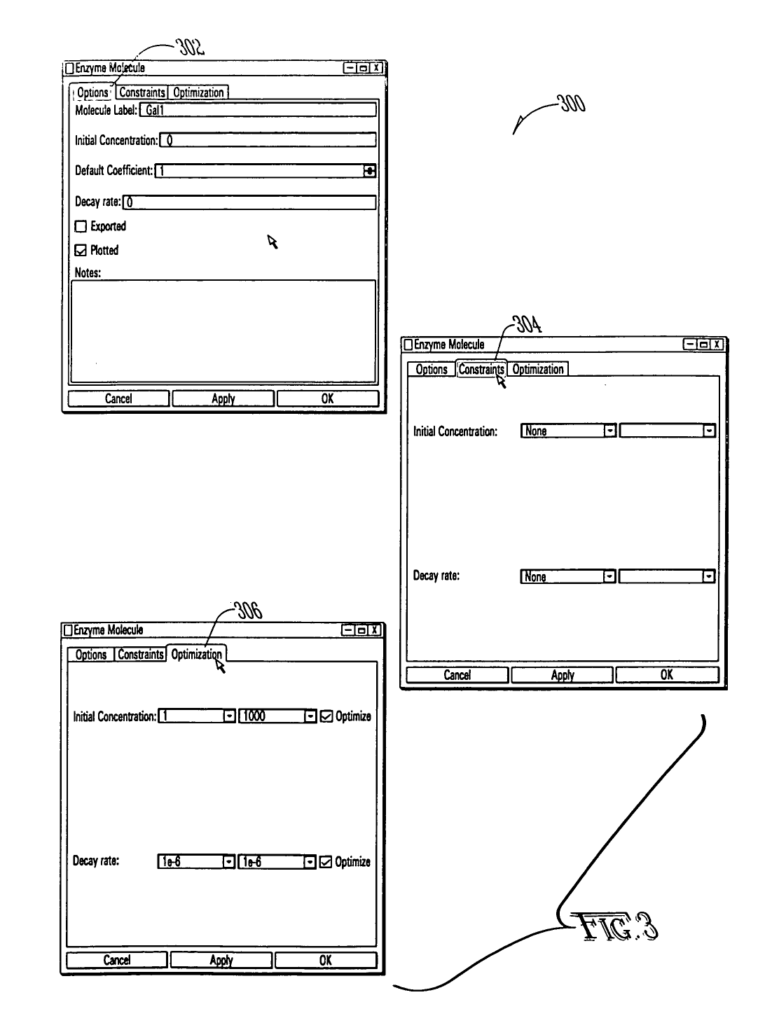

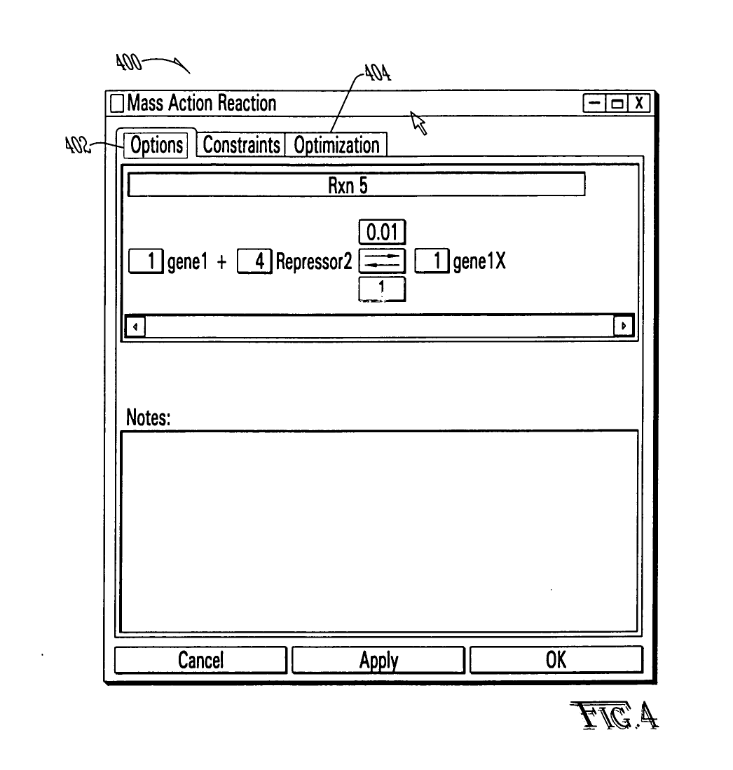

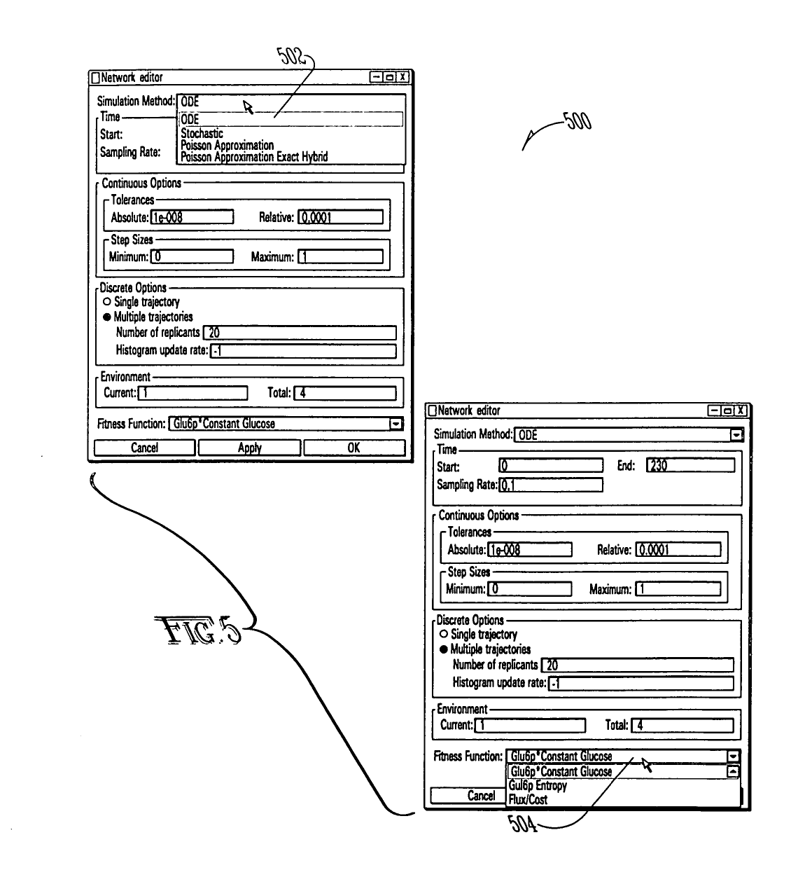

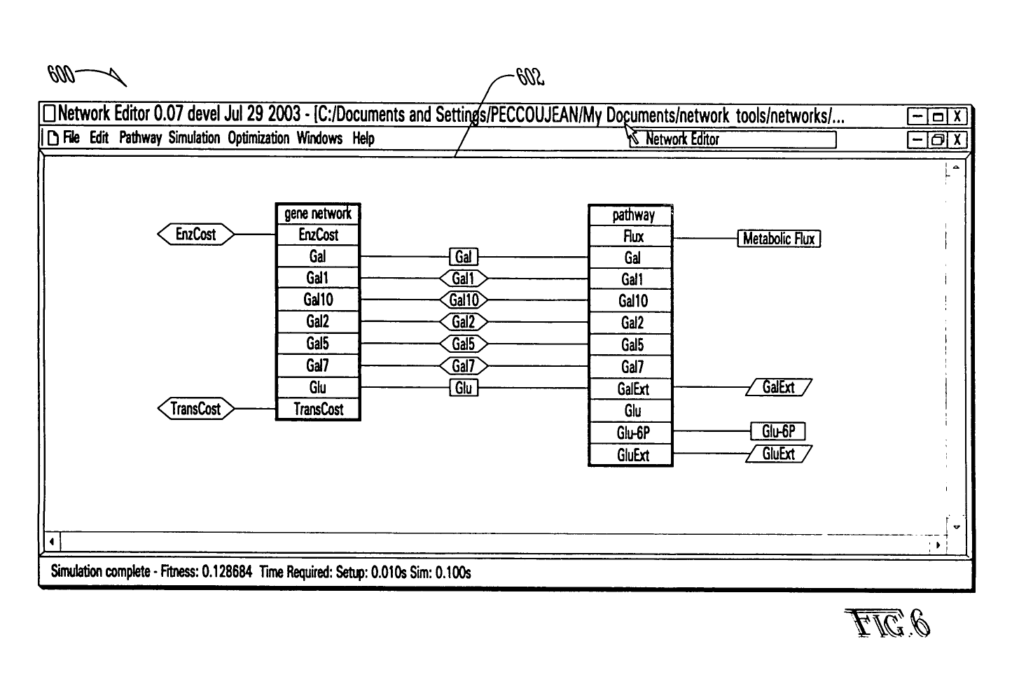

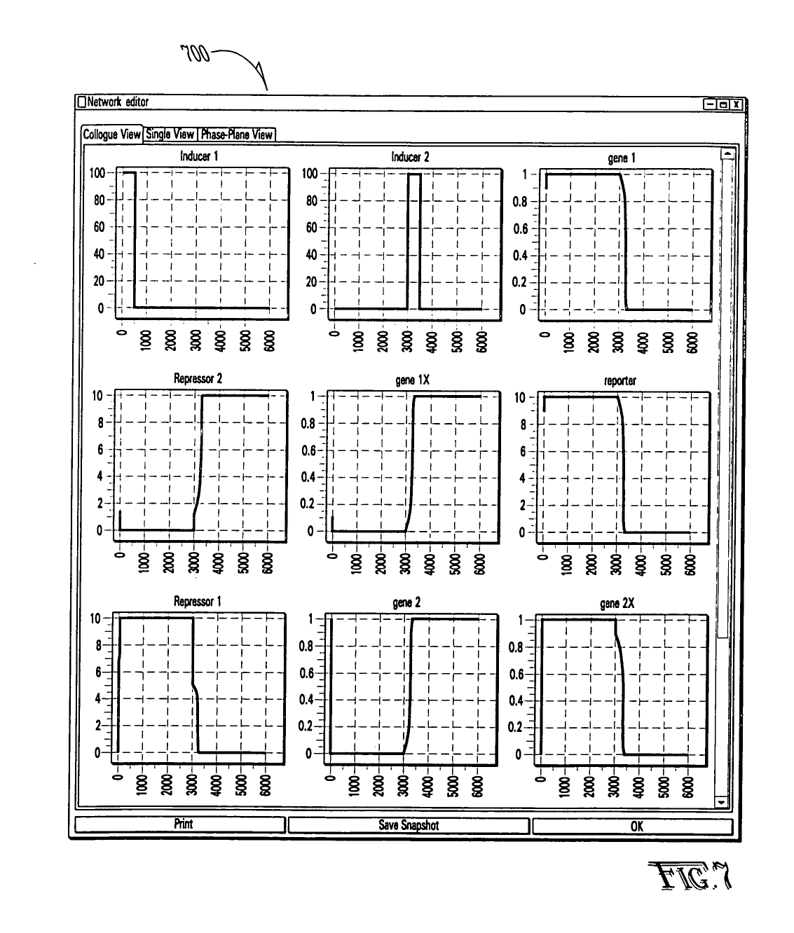

Molecular entities of a network model are represented in the user interface by various graphical objects, such as rectangles and other forms of polygons. These graphical objects may be color-coded and they may have one or more dimensions. When a new network model—or a sub network (subnet)—is constructed, new molecular entities or other variables may be introduced in an object-oriented manner. Referring to FIG. 2, within the network canvas of the user interface, a pop-up menu is shown which lists new objects to be added, including, among others, DNA molecules, mRNA molecule, Enzyme Molecule, and Environmental Molecule. Referring to FIG. 3, a dialog box is provided for each molecule entity, e.g., an Enzyme Molecule (300). The “Option” (302), “Constraints” (304), “Optimization” (306) panes may be used to specify properties of the molecule and parameters for optimization operations. FIG. 4 shows a dialog box for the “Mass Action Reaction” object (400), which similarly allows specification of optimization operations. Therefore, for example, the “Constraints” pane in the dialog boxes for molecules and reactions (304 and 402) of the network model provide text fields that allow the user to specify whether a parameter associated with these molecules or reactions are equal, lower, higher, etc., compared to other parameters of the model. Using the “Optimization” pane (306 and 404), a user may specify the acceptable range of values for these parameters.

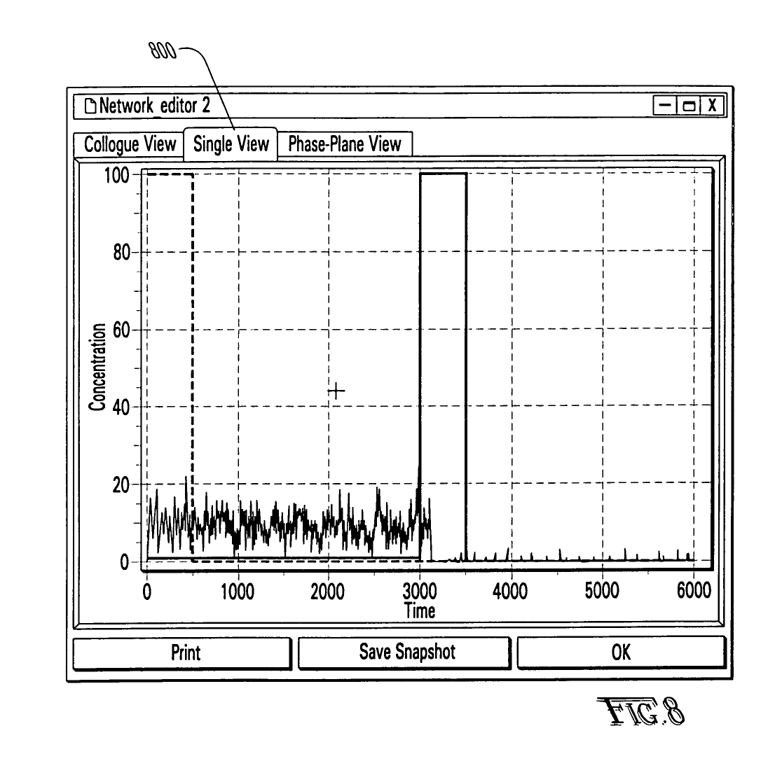

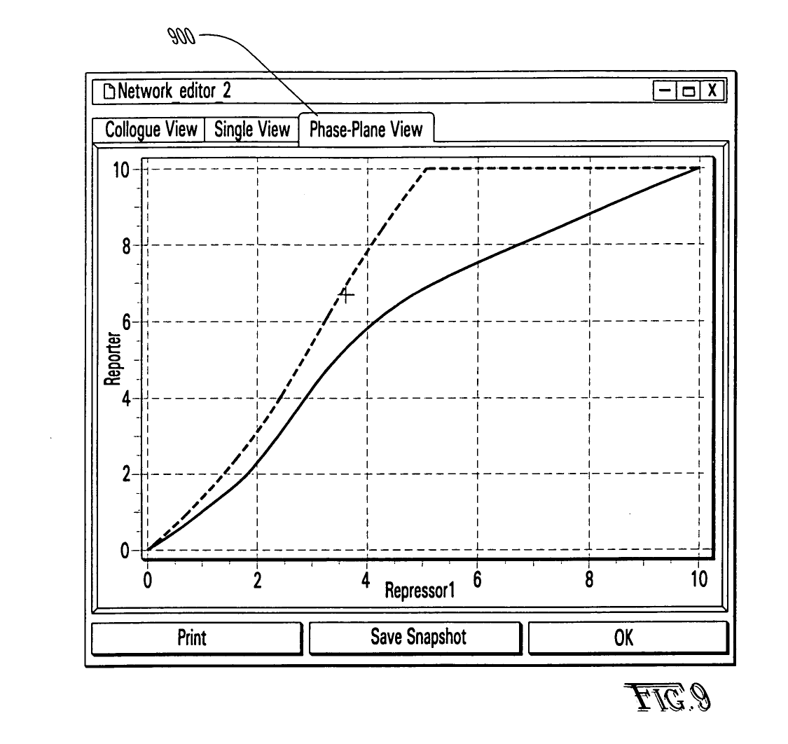

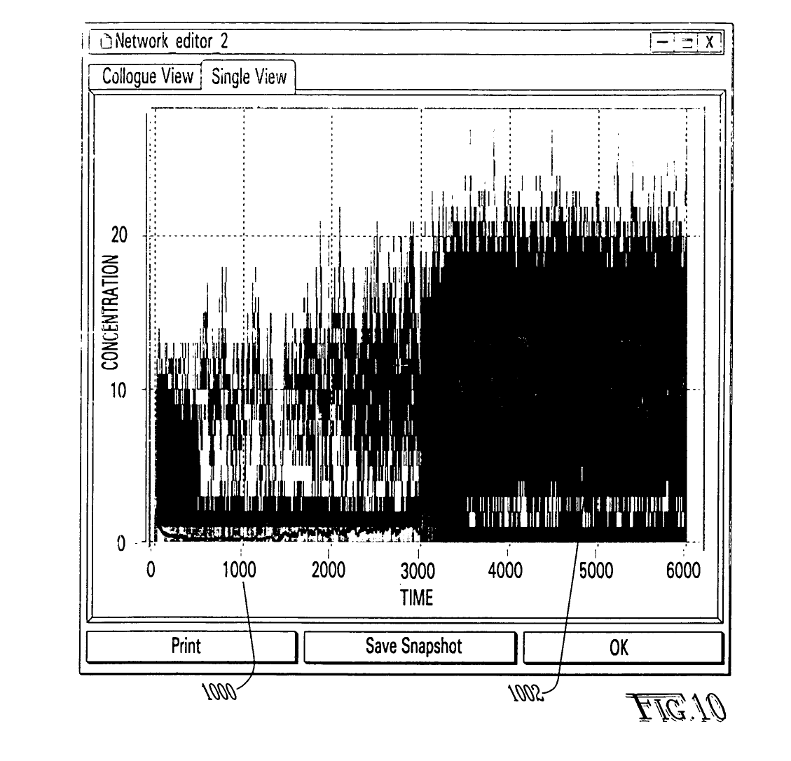

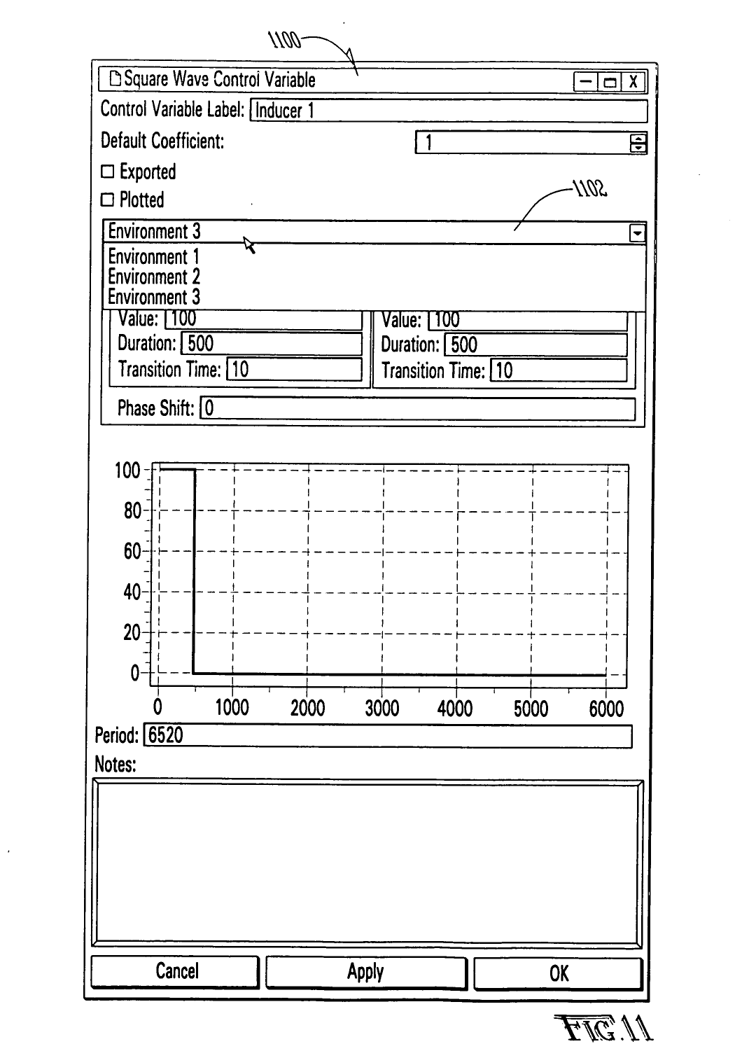

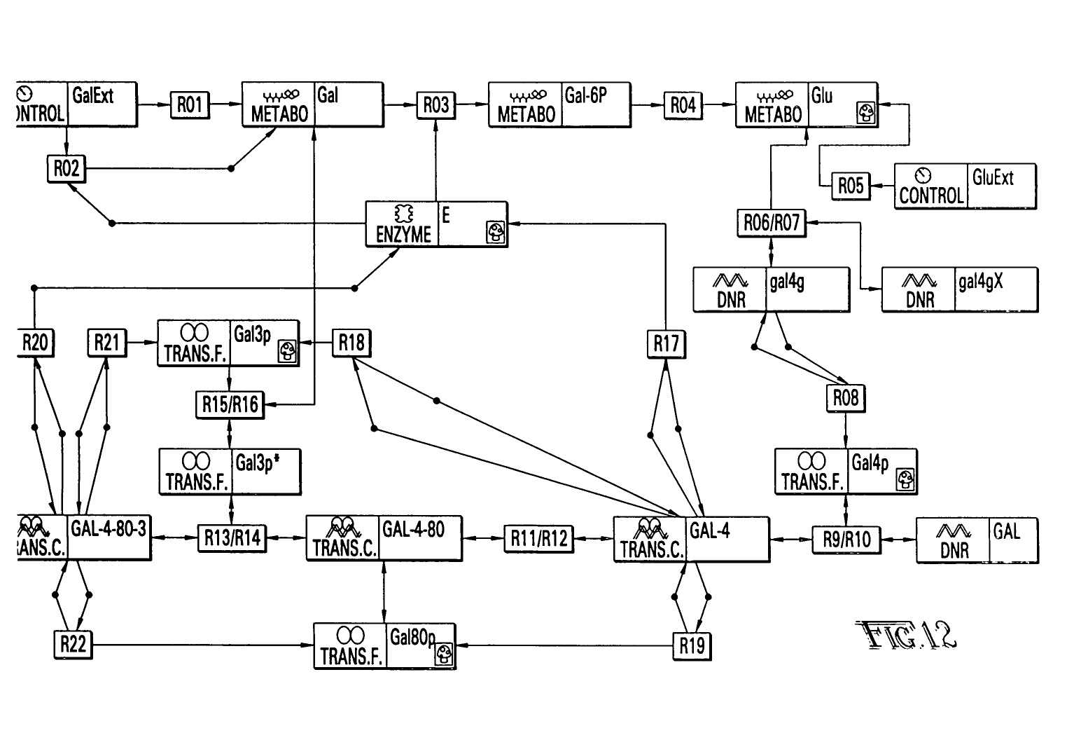

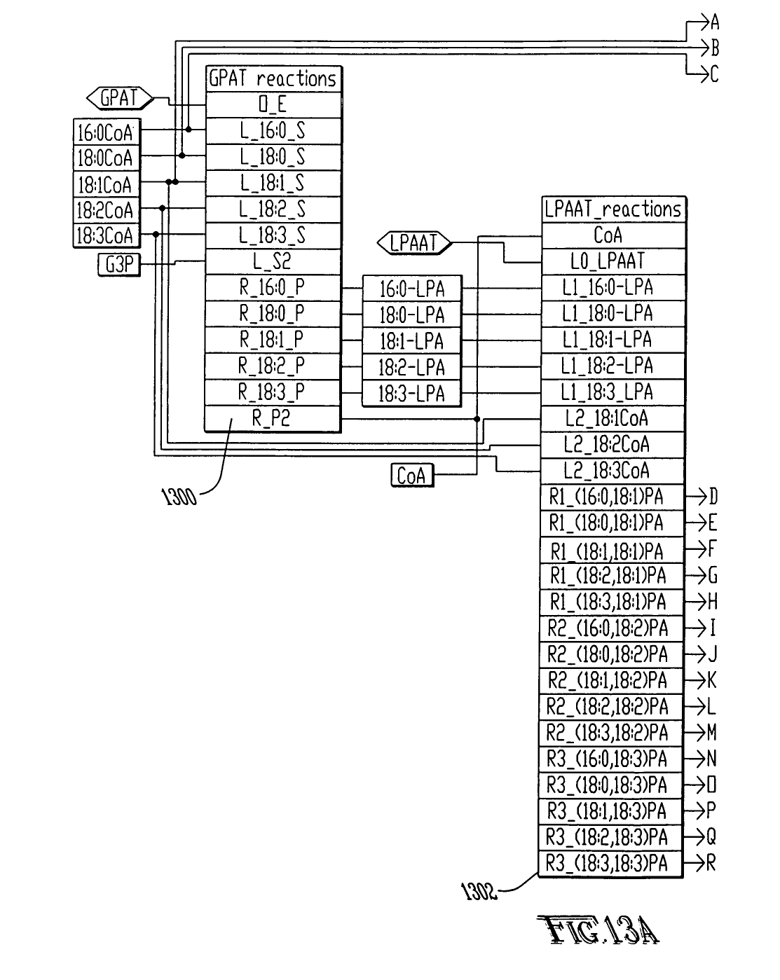

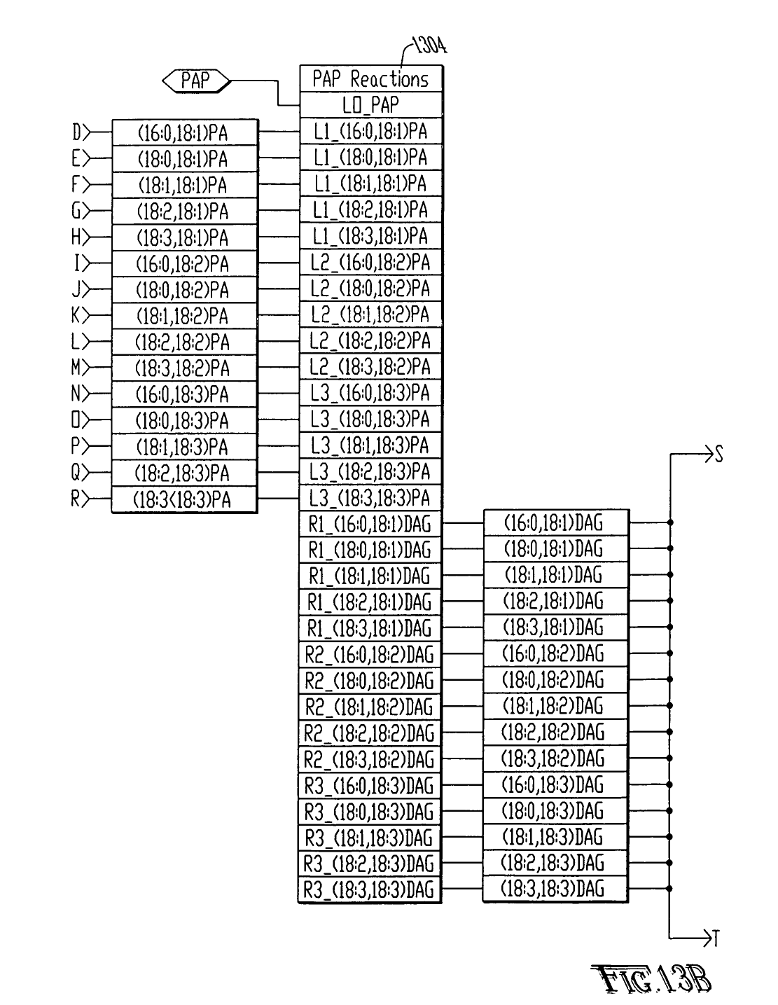

The GP mapping system enables a variety of simulation operations using various simulation engines, such as ordinary differential equations (ODE), stochastic, Poisson Approximation, and Poisson hybrid. Referring to FIG. 5, a dialog box for simulation options (500) is shown. A pull-down list (502) allows the user to specify the specific simulation engine (e.g., ODE, Stochastic, Poisson Approximation, and Poisson Hybrid). Trait functions may also be specified, from another pull-down list (504). Simulation results may be presented through the user interface. Referring to FIG. 6, a screenshot of the user interface (600) is shown upon completion of a simulation. The value of the selected trait function is displayed on the status bar (602) at the bottom of the window (Fitness: 0.128). Simulation may be monitored and analyzed through different views enabled in the user interface. FIG. 7 shows a Collage View (700) of a model trajectory for the time course of several state variables, including several genes, inducers, and repressors. FIG. 8 shows a Single View (800) of a model simulation, reporting several variables. Stochastic simulation is used in this case. FIG. 9 shows a Phase Plane view (900) of a model simulation. One state variable (Reporter) is expressed as a function of another state variable (Repressor1).

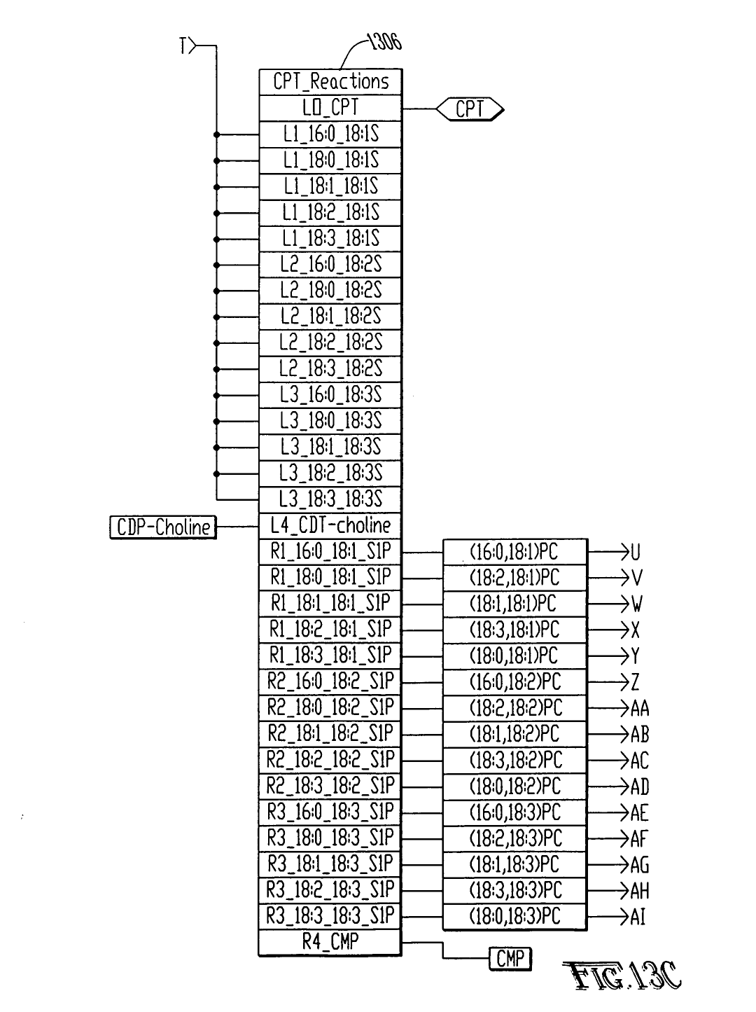

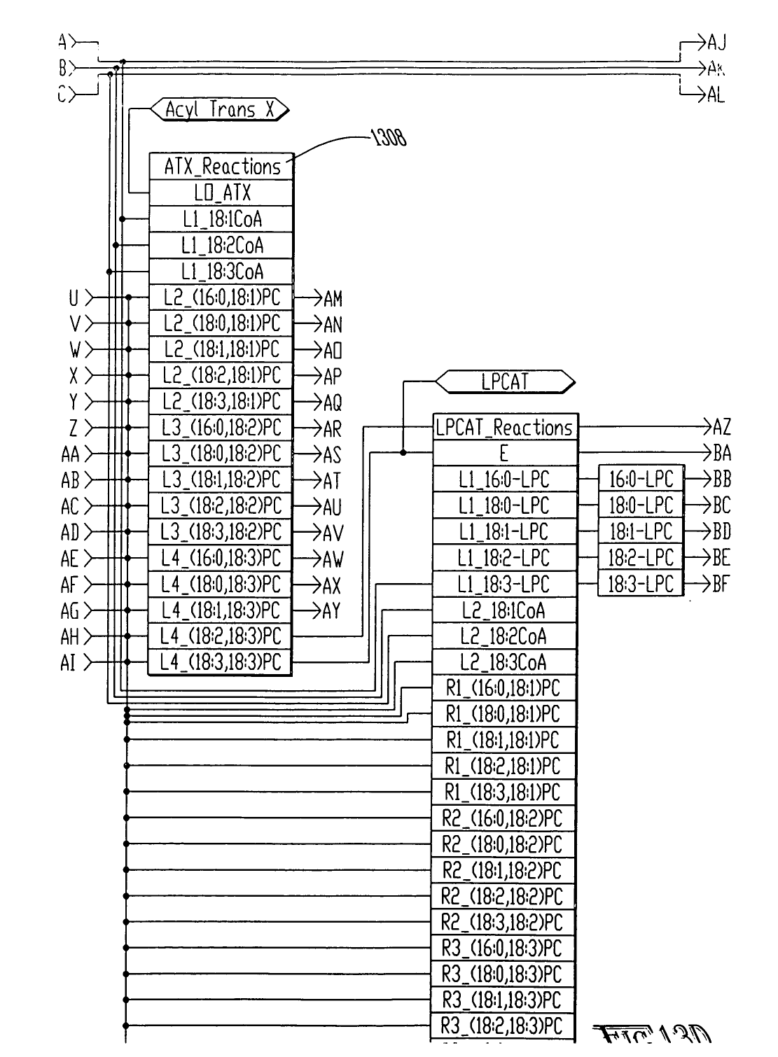

In a further embodiment, the user interface enables visualization of stochastic simulation by a series of histograms of molecule numbers spanning different time points. Referring to FIG. 10, the time evolution (1000) of the statistical distributions of molecule numbers is shown. Such visualization provides a dynamic view of how the distribution changes over time. Superimposed on the graph is a solid line (1002), representing the distribution mean values. Similarly, the limits of the confidence interval of the mean and standard deviations estimates may also be reported on the graph by superimposing additional plots. Such graphic representation may be extended to the visualization of time-evolution of the joint distribution of two or more variables in alternative embodiments.

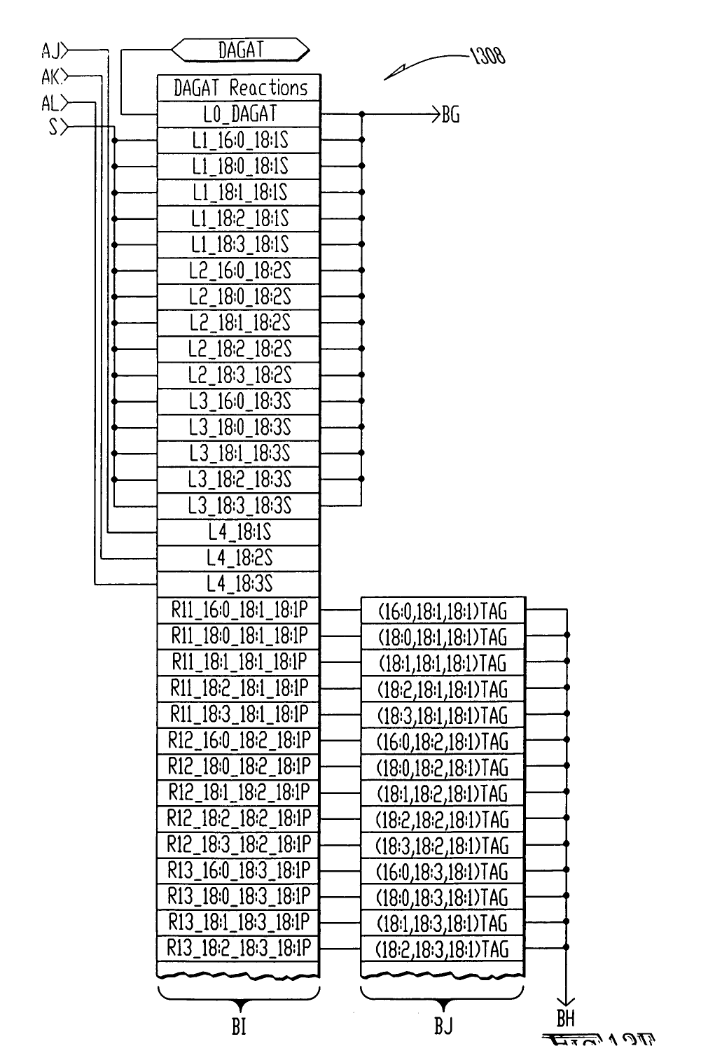

As discussed supra, environmental variables are used in the molecular network model according to this disclosure. Referring to FIG. 11, the time evolution of environmental variables may be specified from a dialog box (1100) in the user interface. Different simulation environments (shown in the pull-down list 1102) may give rise to several evolutions.

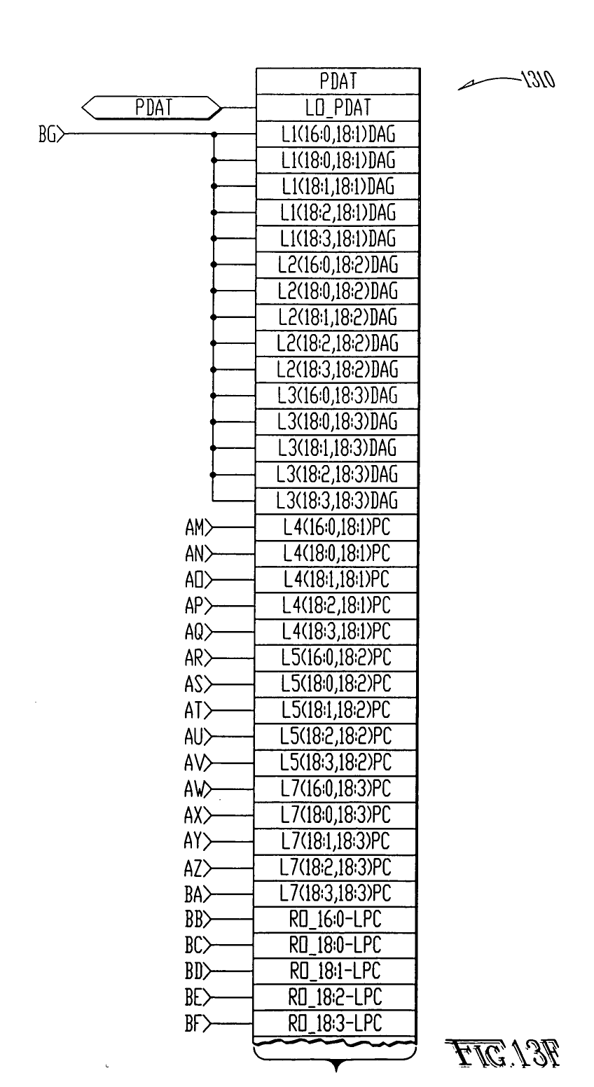

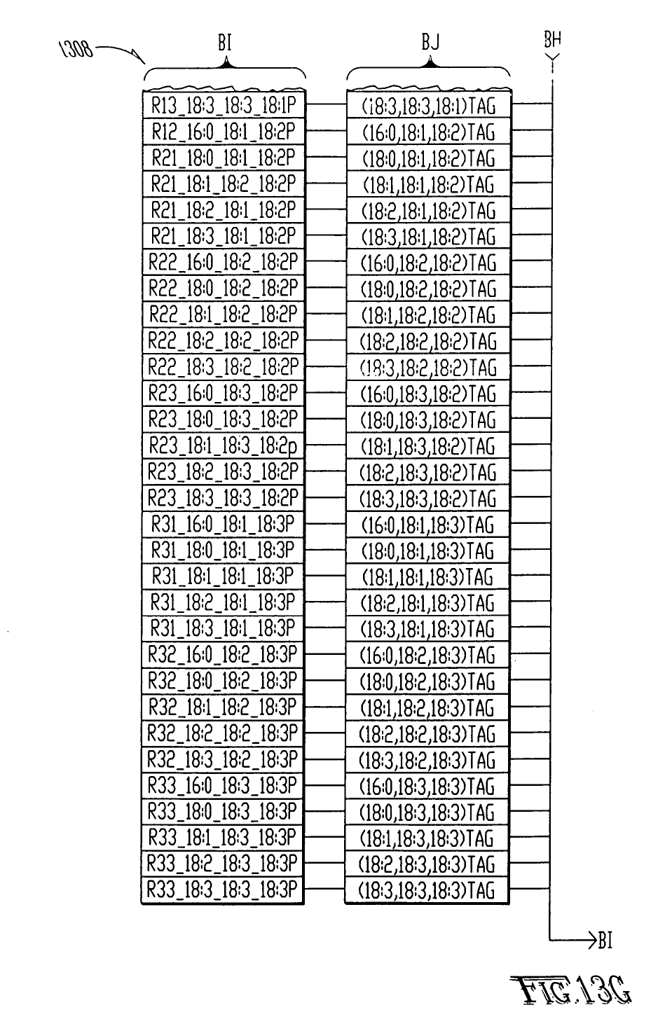

The molecular network may be visualized using Vol'pert diagrams according to one embodiment of this disclosure. These are flat representations of molecular networks. FIG. 12 shows a Vol'pert diagram of a molecular network representing the yeast galactose genetic switch. See also, Example 1 of U.S. Provisional Application No. 60/499,955, filed Sep. 2, 2003. When the number of reactions in a molecular network become very large, e.g., exceeds 100, the use of this kind of flat diagrammatic visualization becomes inadequate. Therefore, in other embodiments, hierarchies of diagrams may be constructed such that a complex model of networks may be partitioned into layered subnets. In still other embodiments, certain details of a complex network may be abstracted away by introducing new graphical objects to substitute for canonic reactions, such as gene activation, gene repression, and certain constitutive enzymatic reactions. For networks that compose of a large number of molecular entities or those that have a high dimension of state space due to certain molecules, the user interface may employ layering, abstraction, and other modified visualization methodologies.

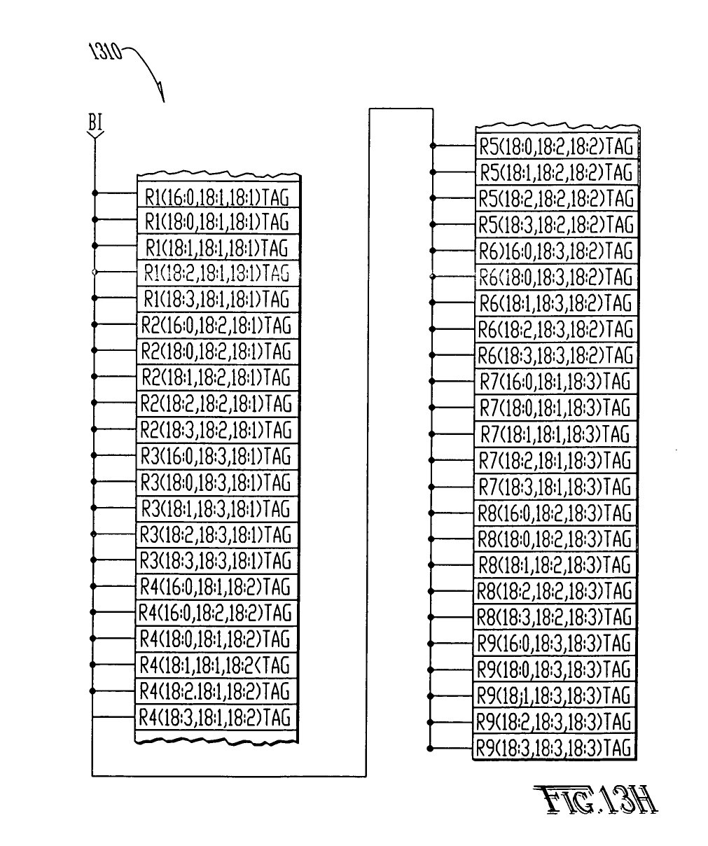

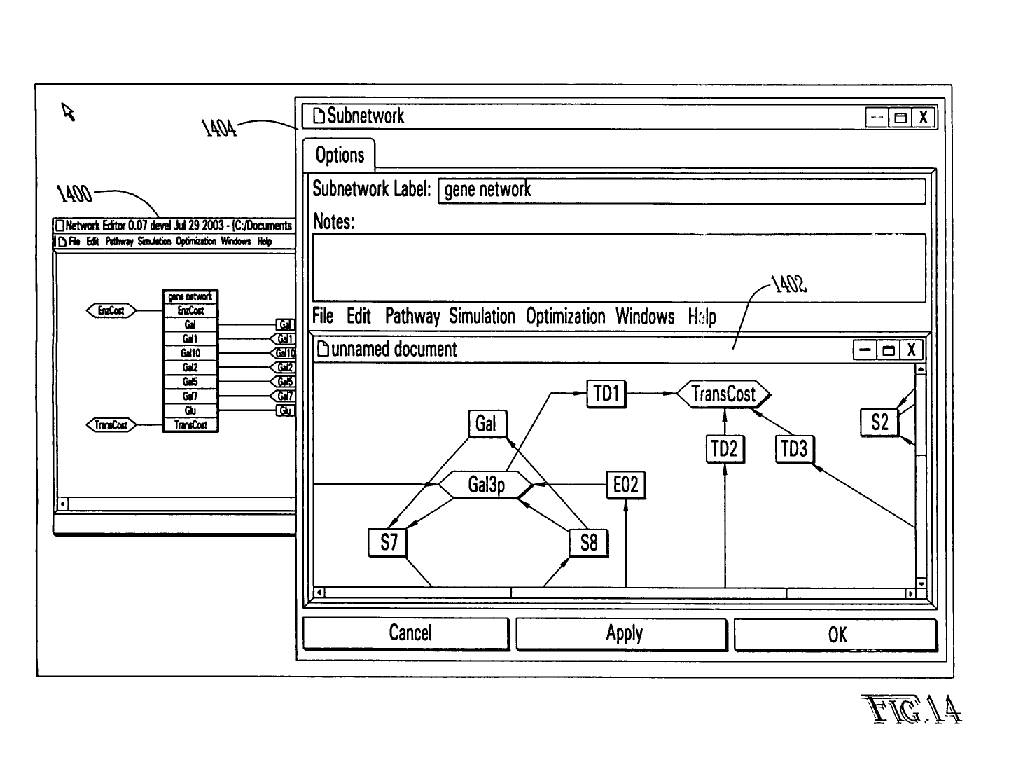

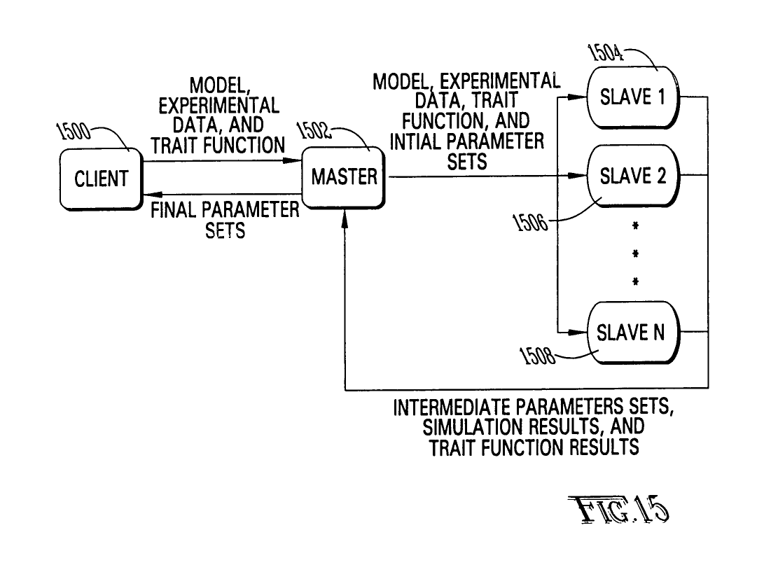

Subnets are shown, for example, with six hierarchical layers (1300, 1302, 1304, 1306, 1308, 1310), in FIG. 13. The details of the lower level hierarchies will be visible by double-clicking on the blocks representing the different subnets. This is a metabolic pathway that includes 484 molecules and 730 elementary reactions. The user interface allows a user to define subnets when constructing a molecular network in the GP mapping system. FIG. 14 shows how a subnet may be recursively defined, in one embodiment, via the user interface. The subnet in this case is designated by a closed box (1400). A pop-up window (1402) allows the user to specify the properties of the subnet. The label or name of the subnet may be specified in the text field (1404). The same menu items for the top-level network (100) as shown in FIG. 1 are provided here (1402). Therefore, the hierarchies of networks support same functions; they are recursively defined. Variables from a lower level may be exported to a higher level, connecting the block representing the subnet at a higher level. See, e.g., FIG. 13. As such, the connecting variables may be extended into elaborative subnets at each of the subsequent layers of the model. In alternative embodiments, subnets may be assembled and linked into a parent model in an object-oriented manner. Files and databases supporting the data and properties of each subnet are linked into the resulting composite network model. In certain embodiments, the size of linking files may be adjusted to facilitate quick loading.

As discussed supra, canonic reactions may be defined and used in the complex (hierarchical or composite) network models; they are referred to as canonic mechanism or motifs. A canonic motif or mechanism occurs not only once in the network model, it typically repeats itself. Different instances of a canonic motif or mechanism may adopt different parameter values. For example, the same Michaelis-Menten mechanism may be used for different enzymes in the network, with different parameter values assigned. In various embodiments, new graphical objects are implemented in the user interface to represent canonic mechanisms. A specific dialog box may be used to pass parameter values. Libraries of canonic motifs or mechanisms may be compiled to enhance the efficiency and accuracy in the construction of complex network models.

Optimizer of the GP Mapping System

The GP mapping system according to this disclosure includes an optimizer. The optimizer runs an optimization strategy to minimize the distance between a set of experimentally observed phenotypes, and the corresponding simulated phenotypes of the network model. A simulated phenotype may be defined by the value of a trait function computed for a particular parameterization of the molecular network model corresponding to a specific genotype and a particular combination of environmental variable time courses corresponding to the environment where the genotype is expressed. A parameterized molecular network minimizing the distance between the observed and the corresponding simulated phenotypes defines the GP map.

Optimization according to this disclosure may be conducted in conjunction with a variety of distances. Some examples of suitable distances can be found at the url: rkb.home.cern.ch/rkb/AN16 pp/node169.html. See also, U.S. Provisional Application No. 60/499,955, filed Sep. 2, 2003. In general, network optimization allows the identification of a best fitting topology, sets of variables, and parameters that match a set of genotype phenotype relationships that have been environmentally observed. When an accurate network topology is known, optimization may be carried out by only exploring the parameter space. In alternative embodiments, to avoid the risk that the network topology may make it impossible to find a good match given a specific set of experimental data, optimization is performed over not only the parameter space but also by exploring alternative topologies (See Francois, P. and Hakim, V. (2004) Design of genetic networks with specific function by evolution in silico, Proc. Natl. Acad. Sci USA 101, 580-585.

In one embodiment, network optimization uses a local area optimization method. In another embodiment, a global search method is used. In other embodiments, both local area and global search is employed. Examples of local area optimization methods include the simplex method, the Newton method, and the gradient descent method. (Press et al, 1992, Numerical Recipes in C, the Art of Scientific Computing, 2^{nd} ed., Cambridge University Press.; Bates, D. M. and Watts, D. G. (1988). Nonlinear regression analysis and its applications. (New-York: John Wiley & Sons).; Dennis, J. E. and Schnabel, R. B. (1983). Numerical methods for unconstrained optimization and nonlinear equations. (Englewood Cliffs, N.J.: Prentice Hall, Inc.; ); Gardner, T. S., D. di Bernardo, D. Lorenz, and J. J. Collins, 2003 Inferring genetic networks and identifying compound mode of action via expression profiling. Science 301: 102-105.; Mendes, P., and D. Kell, 1998 Non-linear optimization of biochemical pathways: applications to metabolic engineering and parameter estimation. Bioinformatics. 14: 869-883.; Moles, C. G., P. Mendes, and J. R. Banga, 2003 Parameter estimation in biochemical pathways: a comparison of global optimization methods. Genome Res. 13: 2467-2474.; Moore, J. H., and L. W. Hahn, 2003 Grammatical evolution for the discovery of Petri net models of complex genetic systems. Genetic and Evolutionary Computation-Gecco 2003, Pt li, Proceedings 2724: 2412-2413; Ronen, M., R. Rosenberg, B. I. Shraiman, and U. Alon, 2002 Assigning numbers to the arrows: parameterizing a gene regulation network by using accurate expression kinetics. Proc. Natl. Acad. Sci. U.S.A 99: 10555-10560.; Sakamoto E. & Iba H. Inferring a system of differential equation for a gene regulatory network by using genetic programming.; Tsuchyia, M., and J. Ross, 2001 Application of genetic algorithm to chemical kinetics: systematic determination of reaction Mechanism and rate coefficients for a complex reaction network. J. Chem. Phys. A. 105: 4052-4058).

They may be used independently, or in combination. Examples of global search methods include a genetic algorithm, differential evolution, simulated annealing, shifting search strategy, and random search. See, id. The optimization strategy applies linear programming in certain embodiments and non-linear programming in alternative embodiments. Both deterministic and stochastic approaches may be used in these contexts and either constrained or unconstrained methods may be adopted depending on characteristics of the network dynamics. When a local area search method is used in conjunction with a global search method, not only improvements may be made in the fitting quality of the resulting parameter set but also the convergence time to solution may be reduced. It is noted that more than one solution may be obtained through the optimization process in certain situations given a specific set of experimental data. One or more of these solutions may be biologically valid. See infra Code Example 3, which provides an exemplary implementation in C for searching the parameter space of a molecular network that models the yeast galactose genetic switch. See also, U.S. Provisional Application No. 60/499,955, filed Sep. 2, 2003.

Application 1: Mapping of the Guet Library of Plasmids

As a demonstration of the successful implementation and application of the described computer system and method we considered a library of plasmids originally described by Guet et al. (Guet, C. C., M. B. Elowitz, W. Hsing, and S. Leibler, 2002 Combinatorial synthesis of genetic networks. Science 296: 1466-1470.) This library contained plasmids consisting of three genes encoding transcription factors (Lacl, TetR, λcl), five promoters to which the transcription factors bind with varying tenacity modifying transcription rates, and a gene (GFP). Through combinatorial arrangement a product of 125 plasmids was possible of which Guet characterized 30. Each plasmid was inserted into an E. coli cell and grown in four different environments where the concentrations of two ligands (IPTG, aTc) were at saturation. These ligands interact with two of the transcription factors (Lacl and TetR respectively) preventing their binding to promoters. This library provides an example of genetic variation (each plasmid is a new genetic construct and mutations were observed), the effects of environmental interaction (growth in the four environments), and an observed phenotype (the concentration of the reporter) by measured fluorescence of GFP.

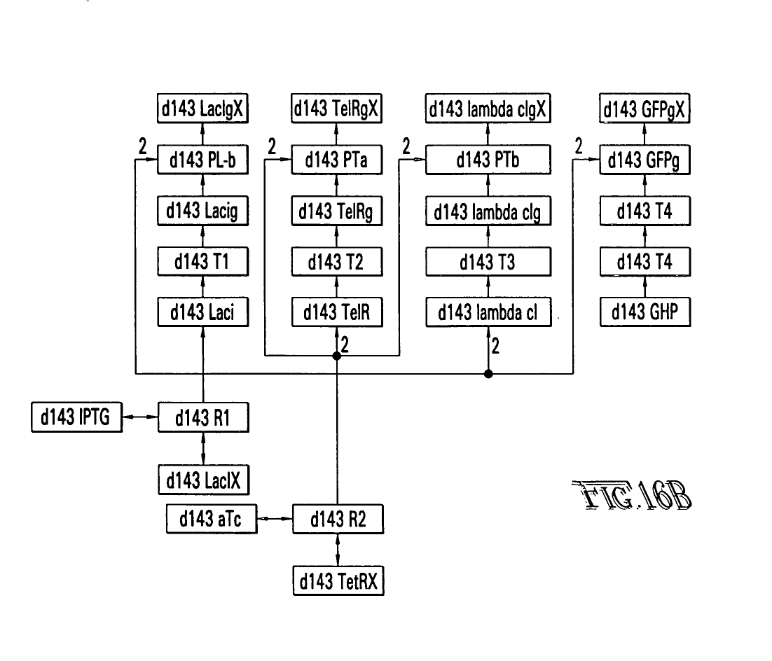

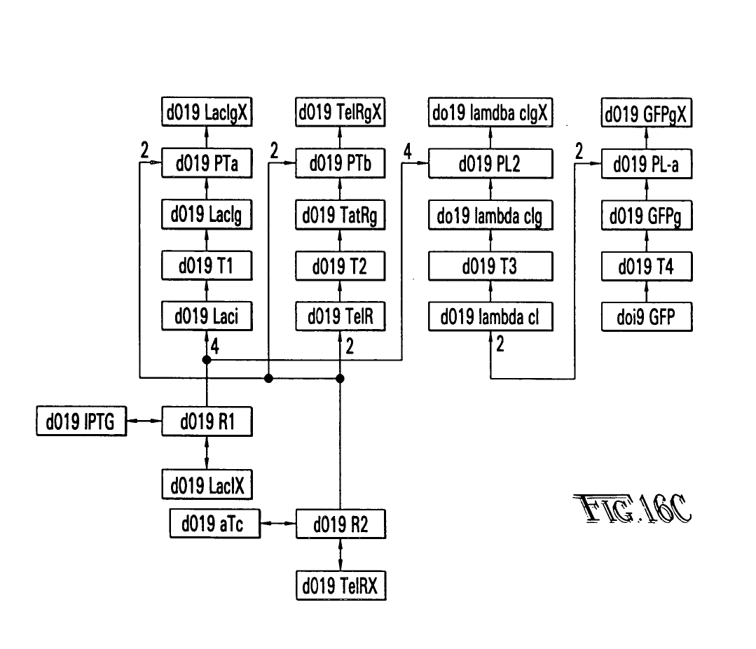

A model was constructed (see below) of three of the plasmids (c101, d019, d143) that share several of the same promoters and thus several model parameters. The design of the model treated each of the three plasmids as independent units represented by the three main subunits in the model graph lacking interconnections. Each component of each subunit is prefixed with the name of the plasmid of which it is a member. Like suffixes represent shared parameters enforced within the model fitting environment. Each subunit also has its own interface to environmental signals IPTG and aTc. The model was built in this fashion to preserve the independence of each plasmid while providing a generic means of expressing shared parameters for model fitting (FIG. 16).

The parameter file below provides a text version of the model by using chemical equation notations. The model parameters are indexed in a table to establish a correspondence between parameters and alleles of genetic loci. In the three different genotypes considered in this example, i.e. the three different plasmids included in the model, some loci are monomorphic while others are polymorphic. The reaction expressing the degradation of Lacl (Reactions 0, 6, and 12) is not polymorphic and therefore associated to a single parameter value. This constraint is expressed by associating the parameter of these three reactions to a single value (index 0 in the parameter table). Other loci corresponding to gene promoters are polymorphic. Because they have identical positions in the three networks, reactions c101_PT (reactions 20/21), d019_PL2 (reactions 36/37), and reactions d143_PTb (reactions 52/53) are three different alleles of the same genetic locus. Hence, they point to different parameters in the optimizer parameter table.

# Reactions

| # RxnName | Param | Index | Rxn Equation |
|---|---|---|---|
| c101 Lacl | 0 | | # c101 Lacl --> 0 |
| d019 Lacl | 0 | | # d019 Lacl --> 0 |
| d143 Lacl | 0 | | # d143 Lacl --> 0 |
| c101 TetR | 1 | | # c101 TetR --> 0 |
| d019 TetR | 1 | | # d019 TetR --> 0 |
| d143 TetR | 1 | | # d143 TetR --> 0 |
| c101 lambda cl | 2 | | # c101 lambda cl --> 0 |
| d019 lambda cl | 2 | | # d019 lambda cl --> 0 |
| d143 lambda cl | 2 | | # d143 lambda cl --> 0 |
| c101 GFP | 3 | | # c101 GFP --> 0 |
| d019 GFP | 3 | | # d019 GFP --> 0 |
| d143 GFP | 3 | | # d143 GFP --> 0 |
| c101 LaclX | 4 | | # c101 LaclX --> 0 |
| d019 LaclX | 4 | | # d019 LaclX --> 0 |
| d143 LaclX | 4 | | # d143 LaclX --> 0 |
| c101 TetRX | 5 | | # c101 TetRX --> 0 |
| d019 TetRX | 5 | | # d019 TetRX --> 0 |
| d143 TetRX | 5 | | # d143 TetRX --> 0 |
| c101 T1 | 6 | | # (c101 Laclg) --> (c101 Laclg) + (c101 Lacl) |
| d019 T1 | 6 | | # (d019 Laclg) --> (d019 Laclg) + (d019 Lacl) |
| d143 T1 | 6 | | # (d143 Laclg) --> (d143 Laclg) + (d143 Lacl) |
| c101 T2 | 7 | | # (c101 TetRg) --> (c101 TetRg) + (c101 TetR) |
| d019 T2 | 7 | | # (d019 TetRg) --> (d019 TetRg) + (d019 TetR) |
| d143 T2 | 7 | | # (d143 TetRg) --> (d143 TetRg) + (d143 TetR) |
| c101 PT | 8 | 9 | # (c101 lambda clg) + 2(c101 TetR) <-> (c101 lambda clgX) |
| d019 PTb | 8 | 9 | # (d019 TetRg) + 2(d019 TetR) <-> (d019 TetRgX) |
| d019 PTa | 8 | 9 | # (d019 Laclg) + 2(d019 TetR) <-> (d019 LaclgX) |
| d143 PTb | 8 | 9 | # (d143 lambda clg) + 2(d143 TetR) <-> (d143 lambda clgX) |
| d143 PTa | 8 | 9 | # (d143 TetRg) + 2(d143 TetR) <-> (d143 TetRgX) |
| c101 T3 | 10 | | # (c101 lambda clg) --> (c101 lambda clg) + (c101 lambda cl) |
| d019 T3 | 10 | | # (d019 lambda clg) --> (d019 lambda clg) + (d019 lambda cl) |
| d143 T3 | 10 | | # (d143 lambda clg) --> (d143 lambda clg) + (d143 lambda cl) |
| c101 PL-a | 11 | 12 | # (c101 GFPg) + 2(c101 lambda cl) <-> (c101 GFPgX) |
| d019 PL-a | 11 | 12 | # (d019 GFPg) + 2(d019 lambda cl) <-> (d019 GFPgX) |
| d143 PL-a | 11 | 12 | # (d143 GFPg) + 2(d143 lambda cl) <-> (d143 GFPgX) |
| d143 PL-b | 11 | 12 | # (d143 Laclg) + 2(d143 lambda cl) <-> (d143 LaclgX) |
| c101 T4 | 13 | | # (c101 GFPg) --> (c101 GFPg) + (c101 GFP) |
| d019 T4 | 13 | | # (d019 GFPg) --> (d019 GFPg) + (d019 GFP) |
| d143 T4 | 13 | | # (d143 GFPg) --> (d143 GFPg) + (d143 GFP) |
| c101 PL2 | 14 | 15 | # (c101 TetRg) + 4(c101 Lacl) <-> (c101 TetRgX) |
| d019 PL2 | 14 | 15 | # (d019 lambda clg) + 4(d019 Lacl) <-> (d019 lambda clgX) |
| c101 PL+ | 16 | 17 | # (c101 Laclg) + 2(c101 lambda cl) <-> (c101 LaclgX) |
| c101 R1 | 18 | 19 | # (c101 IPTG) + (c101 Lacl) <-> (c101 LaclX) |
| d019 R1 | 18 | 19 | # (d019 IPTG) + (d019 Lacl) <-> (d019 LaclX) |
| d143 R1 | 18 | 19 | # (d143 IPTG) + (d143 Lacl) <-> (d143 LaclX) |
| c101 R2 | 20 | 21 | # (c101 aTc) + (c101 TetR) <-> (c101 TetRX) |
| d019 R2 | 20 | 21 | # (d019 aTc) + (d019 TetR) <-> (d019 TetRX) |
| d143 R2 | 20 | 21 | # (d143 aTc) + (d143 TetR) <-> (d143 TetRX) |

# Optimization Parameters Limits

| | | Min Max -or- |
|---|---|---|
| # Param Index | # Param Index | Fixed Value |
| 0 | 0 | 1000000 |
| 1 | 0 | 1000000 |
| 2 | 0 | 1000000 |
| 3 | 0 | 1000000 |
| 4 | 0 | 1000000 |
| 5 | 0 | 1000000 |
| 6 | 0 | 1000000 |
| 7 | 0 | 1000000 |
| 8 | 0 | 1000000 |
| 9 | 0 | 1000000 |
| 10 | 0 | 1000000 |
| 11 | 0 | 1000000 |
| 12 | 0 | 1000000 |
| 13 | 0 | 1000000 |
| 14 | 0 | 1000000 |
| 15 | 0 | 1000000 |
| 16 | 0 | 1000000 |
| 17 | 0 | 1000000 |
| 18 | 0 | 1000000 |
| 19 | 0 | 1000000 |
| 20 | 0 | 1000000 |
| 21 | 0 | 1000000 |

This model was simulated and fitted to data provided by Guet to produce a model that has a response to environmental stimuli similar to that observed by Guet in the plasmids. The numeric results can be seen below. While the residues are nonzero this is not unusual when considering experimental data with inherent noise in the measurement and an unknown baseline. Mean fluorescence measurements of three experiments observed by Guet forming the target of the model fitting procedure are shown in Table 1:

TABLE 1

| Molecule | aTc−/IPTG− | ATc−/IPTG+ | aTc+/IPTG− | aTc+/IPTG+ |
|---|---|---|---|---|
| c101 GFP | 176.703 | 9121.31 | 297.036 | 226.886 |
| d019 GFP | 331.437 | 529.659 | 10787.6 | 168.67 |
| d143 GFP | 14219 | 14124 | 568.389 | 451.398 |

The predicted flourescence measurements by the fitted model are shown in Table 2:

TABLE 2

| Molecule | aTc−/IPTG− | ATc−/IPTG+ | aTc+/IPTG− | aTc+/IPTG+ |
|---|---|---|---|---|
| c101 GFP | 35.0967 | 9078.73 | 34.6756 | 34.7178 |
| d019 GFP | 34.6781 | 34.6756 | 11106.4 | 98.3773 |
| d143 GFP | 12619.2 | 12619.2 | 781.276 | 781.276 |

The error residuals between the experimentally observed and those suggested by the model are shown in Table 3:

TABLE 3

| Molecule | aTc−/IPTG− | ATc−/IPTG+ | aTc+/IPTG− | aTc+/IPTG+ |
|---|---|---|---|---|
| c101 GFP | −141.606 | −42.5757 | −262.36 | −192.168 |
| d019 GFP | −296.759 | −494.983 | 318.792 | −70.2927 |
| d143 GFP | −1599.8 | −1504.8 | 212.887 | 329.878 |

Thus, Application 1 shows that the computer system and method of this invention were successfully used to find parameter values to match the predicted phenotype of the model with the observed phenotype with the predicted phenotype within reasonable experimental measurement error.
Application 2: Application to the Simulation of a Plant Breeding Program

As an additional illustration of the computer system and method of the invention we simulated the genetic switch controlling the galactose metabolism in yeast and its response to selection for a population of individuals. Results indicated is that genes made heterogeneous contributions to phenotypes and that additive and non-additive effects were context dependent. Early cycles of selection suggested strong additive effects attributed to some genes. Later cycles suggested the presence of strong context dependent non-additive effects that were conditional upon the outcomes of earlier selection cycles. A single favorable allele could not be consistently identified for most loci. These results highlight the complexity of non-linear effects associated with genes acting in networks when selection is conducted on a population of individuals segregating for the genes contributing to the network, and demonstrate the usefulness of the present computer system and method for analyzing these non-linear effects. The results of this simulation have been peer-reviewed and published (Peccoud, J., K. Vander Velden, D. W. Podlich, C. R. Winkler, W. L. Arthur et al. 2004 The Selective Values of Alleles in a Molecular Network Model Are Context Dependent. Genetics 166: 1715-1725.).

The galactose pathway represented an attractive system for dynamic modeling since it integrates a gene network, a metabolic pathway, and a response to environmental perturbations. In a first approximation, it was possible to associate the phenotype to the activity of the metabolic pathway and the genotype to the genes in this pathway. Our model of the GAL system (FIG. 12 and Table 4) provided a simple representation of the complex mechanisms of gene expression.

TABLE 4

| Reaction Equation | | A1A1 | A1A2 | A2A2 |
|---|---|---|---|---|
| D01 | Gal80p −−> 0 | 30 | 50 | 70 |
| D02 | Gal4p −−> 0 | 16 | 36 | 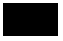 |
| D03 | Gal3p −−> 0 | 22 | 40 | 58 |
| D04 | Glu −−> 0 | 50 | 50 | 50 |
| D05 | E −−> 0 | 66 | 82 | 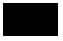 |
| R01 | GalExt −−> Gal | 1 | 1 | 1 |
| R02 | E + GalExt −−> Gal + E | 5 | 6 | 7 |
| R03 | E + Gal −−> Glu-6P + E | 5 | 12 | 19 |
| R04 | Glu-6P −−>Glu | 100 | 100 | 100 |
| R05 | GluExt −−> Glu | 10 | 10 | 10 |
| R06 | Glu + gal4g −> gal4gX | 7 | 10 | 13 |
| R07 | Glu + gal4g <− gal4gX | 1 | 2 | 3 |
| R08 | gal4g −−> gal4g + Gal4p | 4 | 23 | 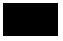 |
| R09 | GAL + Gal4p −> GAL-4 | 3 | 7 | 11 |
| R10 | GAL + Gal4p <− GAL-4 | 8 | 9 | 10 |
| R11 | GAL-4 + Gal80p −> GAL-4-80 | 2 | 3.5 | 5 |
| R12 | GAL-4 + Gal80p <− GAL-4-80 | 3 | 5 | 7 |
| R13 | Gal3p* + GAL-4-80 −> GAL-4-80-3 | 6 | 8 | 10 |
| R14 | Gal3p* + GAL-4-80 <− GAL-4-80-3 | 1 | 10 | 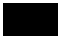 |
| R15 | Gal + Gal3p −> Gal3p* | 1194 | 1320 | 1446 |
| R16 | Gal + Gal3p <− Gal3p* | 700 | 809 | 918 |
| R17 | GAL-4 −−> GAL-4 + E | 10 | 19 | 28 |
| R18 | GAL-4 −−> GAL-4 + Gal3p | 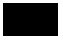 | 2 | 3 |
| R19 | GAL-4 −−> GAL-4 + Gal80p | 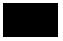 | 101 | 187 |
| R20 | GAL-4-80-3 −−> GAL-4-80-3 + E | 330 | 336 | 342 |
| R21 | GAL-4-80-3 −−> | 178 | 309 | 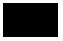 |
| | GAL-4-80-3 + Gal3p | | | |
| R22 | GAL-4-80-3 −−> | 294 | 338 | 382 |
| | GAL-4-80-3 + Gal80p | | | |

TABLE 4 lists the chemical equations and parameters of the model of the galactose switch in yeast. Reactions are labeled in the first column and the chemical equation of the reaction is given in column 2. Each parameter has two allelic values A1 and A2. The columns A1A1, A1A2, and A2A2 indicate the parameter values used when genotypes are homozygous (A1A1 and A2A2) or heterozygous (A1A2). Parameters in bold characters indicate the genotype of the individual with the highest performance that was generated at the 35^{th} generation of the 34^{th} run. Parameters highlighted by a gray background corresponded to the favorable alleles that were consistently fixed in more than 95% of the 1,000 runs. Lines (Reactions) in italic were non-segregating in Experiment 1 and Experiment 2 because they correspond to interactions outside of the GAL system. Parameter values highlighted in gray were made non-segregating in Experiment 2.

Table 4 is representative of the common understanding of the molecular mechanisms responsible for the response of yeast to the presence of galactose and glucose in its environment. To date, the effect of the environment has often been ignored in models of gene networks or considered as a set of external parameters, where simulation runs with various parameter values can be compared to evaluate the impact of the environment on the model dynamics (Venkatesh, K. V., P. J. Bhat, R. A. Kumar, and P. Doshi, 1999 Quantitative model for Gal4p-mediated expression of the galactose/melibiose regulon in Saccharomyces cerevisiae. Biotechnol. Prog. 15: 51-57). For many situations it seems that this approach is able to capture the biological logic of the network. However, in the case of the galactose pathway of yeast, the environment can change the state of the genetic switch by inducing or repressing the expression of the GAL genes. Therefore, in the case of the galactose pathway of yeast, as this case in genotype to phenotype mapping, the relationship between the network and its environment is not one-way. The induction of the GAL genes by galactose results in the transformation of galactose into glucose. This transformation introduces a feedback loop by which the induced state of the GAL system leads to a modification of the environmental conditions that lead to this induction. In an effort to capture this behavior, we introduced in the model to environmental variables GalExt and GluExt, which can be regarded as external pools of molecules not affected by the dynamics of intracellular reactions. Passive diffusion or active transport of these molecules into the cell can be represented by chemical equations transforming these molecules into their intracellular counterparts, Gal and Glu, respectively (reactions R01, R02, and R05 in Table 1). Gal and Glu can be regarded as the variables indicative of the intracellular environment. The value of the two environmental variables GalExt and GluExt indicate the presence of sugars in the environment. Absence and presence were indicated by 0 and 10, respectively. The combination of GalExt and GluExt values defines an environment.

In the case of the GAL system, the most obvious trait is the capability to process galactose when it is the only source of carbon available. We elected to use the variable Glu-6P as an indicator of the state of the galactose pathway. In order to quantify the trait, we assigned values for Glu-6P in the 3 environments (we ignore the trivial case where no sugar is present Gal−Glu−). Arbitrarily, we decided that Glu-6P should be 0 in the two environments where the pathway should not work (Gal-Glu+, Gal+Glu+) and 2 in Gal+Glu−. The system of differential equations was integrated between t=0 and t=10⁴ at which point the final derivative values were tested and if within a threshold of zero assumed to have reached steady-state. By noting X₋₊(10⁴) the value of Glu-6P at time 10⁴ in the Glu+Gal− environment, this first trait function is:

$${T}_{1} ( {k}_{1} , K , {k}_{27} ) = \sqrt{{( {X}_{+ -} ( {10}^{4} ) - 2 )}^{2} + {( {X}_{++} ( {10}^{4} ) - 0 )}^{2} + {( {X}_{- +} ( {10}^{4} ) - 0 )}^{2}} .$$

A second trait function was also defined for this model. Comparable levels of external galactose and glucose were expected to lead to comparable levels of internal glucose. By noting Y₋₊(10⁴) the value of Glu at time 10⁴ in the Gal-Glu+ environment, this second trait function was defined as:

$${T}_{2} ( {k}_{1} , K , {k}_{27} ) = \sqrt{{( {Y}_{+ -} ( {10}^{4} ) - 2 )}^{2} + {( {Y}_{++} ( {10}^{4} ) - 2 )}^{2} + {( {Y}_{- +} ( {10}^{4} ) - 2 )}^{2}} .$$

A trait value can be computed for each of the genotypes of the genetic spaced considered in this article.
So, for instance,

T₁(30,36,22,50,66,1,7,5,100,10,7,1,4,3,8,2,3,6,1,1194,700,10,1,15,330,178,294) is the trait value of the genotype where all loci are A1A1 expect D02 (A1A2) and R02 (A2A2).

A numerical performance function is computed for selection purpose. This summarizes results from a number of elementary traits that determine how well an individual performs in a given environment. In the context of this work, we considered Φ(k₁,K,k₂₇)=T, (k₁,K,k₂₇).T₂(k₁,K,k₂₇) to describe the combination of several trait valued in a performance function. To simulate effects of selection operating on the model of the galactose pathway, we developed a simple genetic algorithm application that was interfaced with a gene network simulator utilizing CVODE (Cohen, S. D., and A. C. Hindmarsh, 1996 CVODE, a stiff/nonstiff ODE solver in C. Computer in Physics 10: 138-143.). We simulated a mass selection strategy where the phenotype of an individual is the only criterion used to evaluate the performance of a genotype. The initial population (500 individuals) contained equal numbers of each allele at all segregating loci in the galactose pathway model. A constant selection pressure of 20% was applied to all cycles of selection across all simulations. We simulated a case where there was sustained directional selection for smaller values of the performance function over 100 cycles of selection. One thousand replicates of the simulation were conducted.

In order to assess the way individuals are scored by the performance value, we looked for the individual with the lowest performance value that was generated across the entire experiment. This individual was found at the 35^{th} cycle of run 34. It is interesting that this individual was not found in the population generated at the end of the selection process (cycle 100). The performance value of the best individual is approximately 0.025 (see Table 5).

TABLE 5

| Environment | Glu-6P | Glu |
|---|---|---|
| Gal−Glu+ | 0.000000 | 2.000000 |
| Gal+Glu− | 1.994018 | 3.988036 |
| Gal+Glu+ | 0.011255 | 2.022515 |
| Performance = 0.025341 | T₁ = 0.012746 | T₂ = 1.988163 |

TABLE 5: In order to illustrate how performance is computed, the performance of the best performing individual generated across the entire simulation is computed in this table. This individual was found in the 35^{th} generation of the 34^{th} run of the simulation. Simulations were run in the 3 different environments containing sugars and the value of Glu-6P and Glu at t=10⁴ are reported in this table. The two trait values can be derived from these data by using the mathematical expression of the corresponding trait functions. The performance score is the product of the two trait values. The values achieved at the end of the selection process are typically close to 0.20. This 8-fold difference tends to indicate that a dramatic loss of performance occurred during the selection process. That is when it becomes necessary to examine how these performance values are achieved, ie. the property of the trait and performance functions used in the simulation. The values in Table 5 demonstrate that that the target values for Glu-6P are reached in the three environmental conditions and T; can reach a very low value. This is not the case for T₂. The target values for Glu are reached in Gal-Glu+ and Gal+Glu+conditions but we cannot get close to the target value of 2 in the Gal+Glu− condition. When the best individual is compared to the best individuals typically found in the last cycle of selection, it turns out that their behavior is very comparable. Minimal changes in Glu-6P values result in a significant difference in the T₁ value, which propagates to the performance value. Even more interesting is the examination of the time-evolution of Glu-6P and Glu when the molecular network was integrated. Asymptotic values were quickly reached in Gal−Glu+ and Gal+Glu− but the system oscillates when placed in Gal+Glu+conditions. The amplitudes of the oscillations are significant (0.5 for Glu and 0.3 for Glu-6P) but the values are close to the target values at t=10⁴. This shows that the outcome of the selection process is a function of the trait and performance functions.

In order to complete the 1,000 runs in an acceptable time (approximately 15 hours), the simulations were distributed over the 56 nodes of a Linux cluster, each node having two processors. The selection process simulated in this experiment is extremely basic. Its implementation did not require much programming. In order to analyze the response of regulatory networks for use in breeding programs, we also interfaced the molecular network simulation environment with QU-GENE, an environment for simulating breeding strategies (Micallef, K. P., M. Cooper, and D. W. Podlich, 2001 Using clusters of computers for large QU-GENE simulation experiments. Bioinformatics. 17: 194-195.; Podlich, D. W., and M. Cooper, 1998 QU-GENE: a simulation platform for quantitative analysis of genetic models. Bioinformatics. 14: 632-653.).

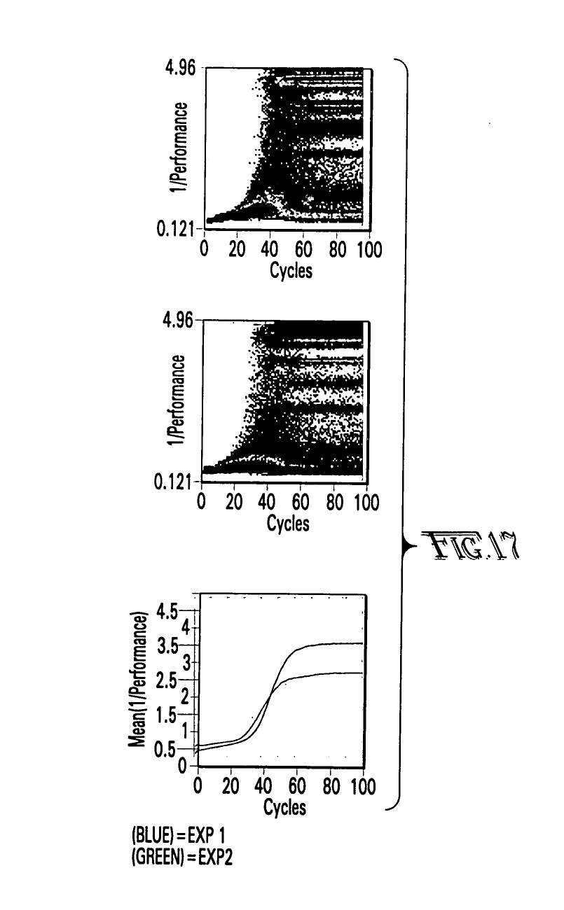

There are two ways to analyze the network response to selection. The time-evolution of performance is indicative of the effect of selection while the time-evolution of allele frequencies tells us how this effect is achieved. Two experiments (series of 1,000 simulations with identical parameters and initial conditions) were conducted. In Experiment 1, the only non-segregating loci were those corresponding to interactions that are often considered “outside” the Galactose switch. In a second experiment, Experiment 2, we also fixed the favorable alleles of loci having an additive effect in the results of Experiment 1. To assess the response to selection of this genetic system, the statistical distribution of the inverse of the mean performance value was plotted (FIG. 17). As shown in FIG. 17, data was recorded during Experiment 1 and Experiment 2, each consisting of 1,000 simulations. Histograms of the inverse of the population average performance values were computed for each of the 100 cycles of selection. The frequency of each performance category was color-coded. Results from Experiment 1 (left) show that the distribution is clearly non-normal since it exhibits at least eight modes. Beyond cycle 80, the selection process has reached its asymptotic distribution. The distribution observed in Experiment 2 (center) is fairly similar to results of Experiment 1. The main difference is the weight of the bottom mode (blue peak) indicating that a large fraction of the simulations never achieved good performance values. In order to better compare these two distributions, the time evolutions of their mean values were plotted on the third graph (right). It shows that better performance is achieved in Experiment 2 (green line) for the early phases of the selection process, while Experiment 1 had better performance than Experiment 2 for the long term response to selection.

The statistical distribution of mean performance values is initially unimodal (FIG. 17, left). Beyond cycle 50 or so up to eight modes can be identified. Interestingly, there is a mode corresponding to poor levels of performance. There are also two major modes corresponding to good performance and a few minor modes of intermediate values. Beyond cycle 50, the selection process appears to have reached its asymptotic distribution. However, the observation of individual trajectories indicates that despite a constant selection pressure, the populations can move from one mode to the other resulting in quick gains or losses of performance even in the stationary regime. This pattern indicates that the performance landscape has multiple local maxima and that the fluctuations of the selection process are large enough to move the population from one peak to the next.

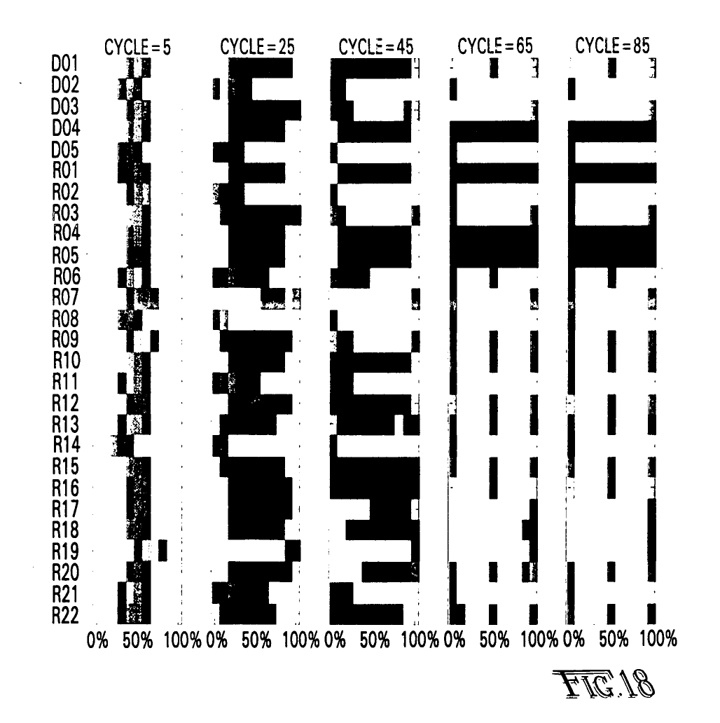

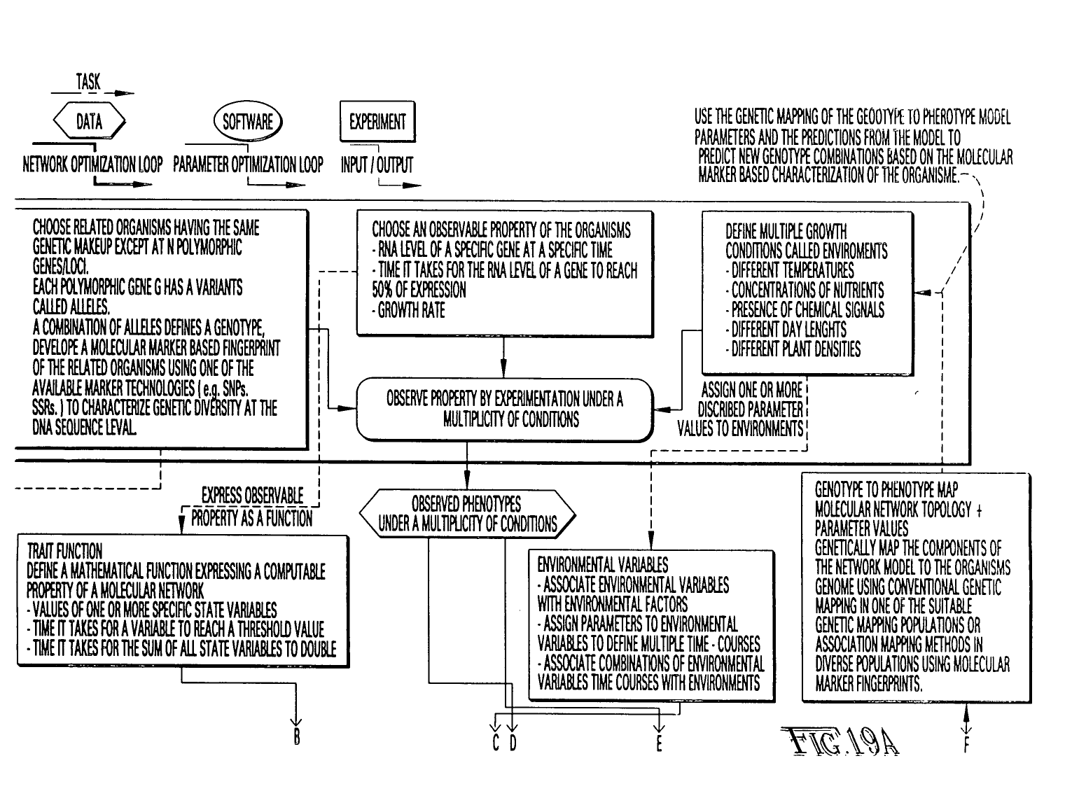

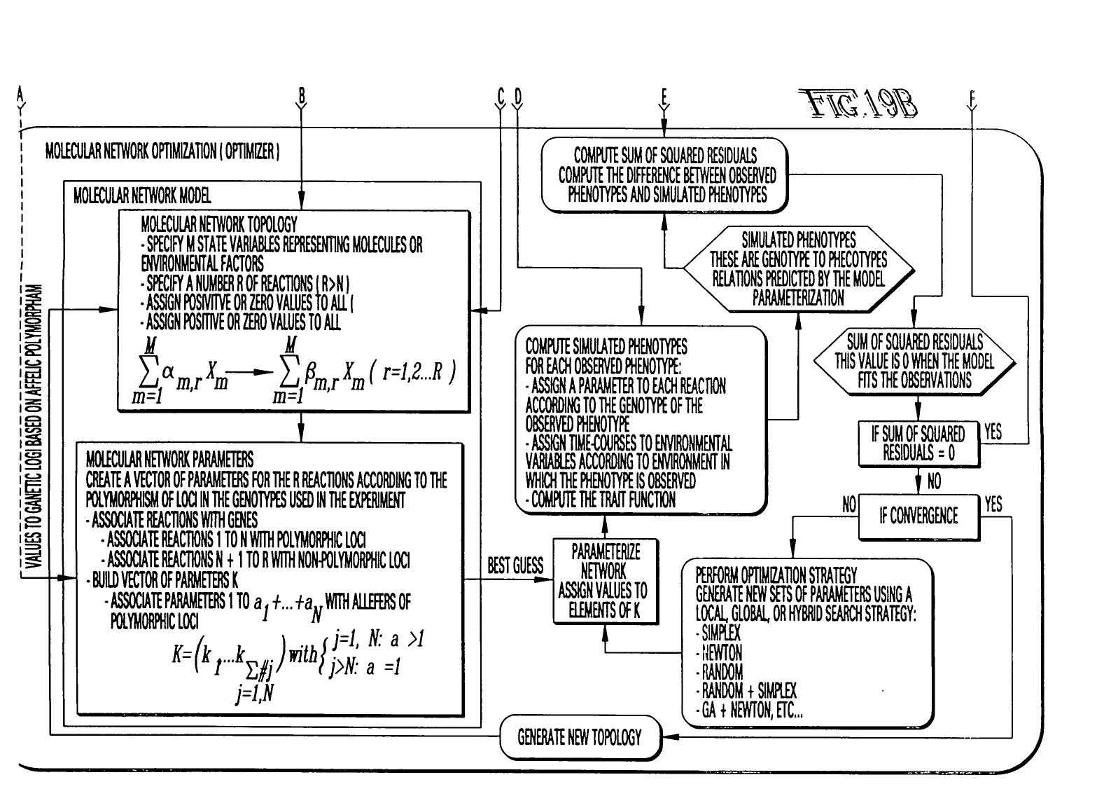

Allele frequencies exhibit a fairly complex behavior at most loci (FIG. 18). FIG. 18 represents the Monte-Carlo simulations and shows the frequencies of allele A1 at each of the 27 recorded loci. Histograms of these frequencies are color-coded. To illustrate the effect of the selection process on the genetic makeup of the population, five histograms corresponding to the selection cycles 5, 25, 45, 65, and 85 are displayed. In Experiment 1, D02, D05, R08, R14, R18, R19, R21 had one of their two alleles consistently fixed in more than 95% of the simulations. For most loci, however, no allele is fixed. Frequency distribution is multimodal with peaks at 0%, 100% and often 50%. Non-polymorphic loci (D04, R01, R04, and R05) exhibit a pattern indicative of genetic drift. Indirectly, they indicate that all other loci have some selective value. Plots at cycle 65 and 85 are very similar indicating that the asymptotic distribution of the process has been reached. Results of Experiment 2 were generally similar (not shown).

As mentioned above, fixation of one of the two alleles in more than 95% of the runs is observed for seven loci (D02, D05, R08, R14, R18, R19, R21). In the other cases the final allele frequencies were variable and distributed between 0 and 1 with peaks at 0%, 50%, and 100%. Thus, either one of the homozygotes or the heterozygote could be favored depending on the replicate. So for most loci it is not possible to clearly identify a consistently favorable allele; the favorable allele is highly context dependent. This example illustrates the benefits of using molecular networks models as genotype to phenotype maps. The results of simulations like these are highly useful for informing plant breeder which loci to focus upon when selecting for a trait of interest. Breeders should focus on the few loci that are consistently fixed because they are the only ones having a predicitive contribution to a trait. More generally, they make it possible to predict, at the population level, the genetic properties of traits resulting from the network of molecular interactions controlling the expression of this trait. This information can, for instance, be used to identify markers to be used in marker assisted selection strategies.

Distributed Computing in the GP Mapping System

Whether optimization or simulation, computing associated with network models may be excessively time-consuming. As models increase in size and trait or fitness functions increase in complexity, the number of possible solutions to be tested may dramatically increase. To deal with such a challenge in computing, the GP mapping system of this disclosure adopts a distributed architecture in one embodiment, allowing distributed evaluation of populations of molecular network models. Multiple computers may be linked via a local or wide area network, wired or wireless, each capable of processing one or more computing tasks in the GP mapping system.

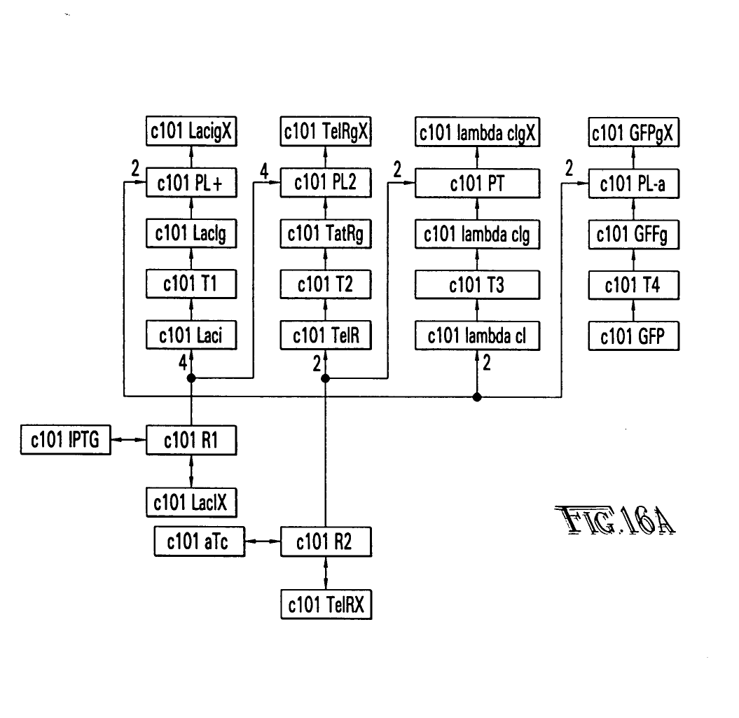

For example, referring to FIG. 15, a user desktop interface, Client (1500), sends the initial model and related experimental data to a computational master server, Master (1502). Master (1502) maintains a list of known computational slave machines, e.g., Slave1 (1504), Slave2 (1506), . . . , SlaveN (1508), to which parts or sections of the optimization task are sent, in the form of various parameter sets. Computational slaves may exist on any computer or machine connected to the master server over a network, either in a cluster, grid, desktop, or massive multiprocessor environment. After a slave has completed the simulation and/or optimization on its section, the results are returned to the master, including, e.g., intermediate parameter sets, simulation results, and trait function results. Master (1502) then compiles the results from the slaves, performs additional computation and analysis on the results or generates alternative solutions where necessary, and then returns the final solution (e.g., final parameter set) to Client (1500). The distributed computing therefore greatly scales the computing capacity of the GP mapping system. This architecture may be used both for solving optimization problems and for stochastic simulations in various embodiments.

The following examples further describe the various embodiments. They are illustrative of the disclosed embodiments but do not limit the same in any manner.

### CODE EXAMPLE 1

### A Code Segment in C Implementing Differential Equations Representing Network Dynamics

f(integer N, real t, N_Vector Y, N_Vector Y2, void*f_data){const double*KC=(double*)f_data;
   double r0=KC[1]*N_VIth(Y, 0);
   double r1=KC[1]*N_VIth(Y, 0)*N_VIth(Y, 11);
   double r2=KC[2]*N_VIth(Y, 1)*N_VIth(Y, 11);
   double r3=KC[3]*N_VIth(Y, 2);
   double r4=KC[4]*N_VIth(Y, 8)*N_VIth(Y, 9);
   double r5=KC[5]*N_VIth(Y, 10);
   double r6=KC[6]*N_VIth(Y, 9);
   double r7=KC[7]*N_VIth(Y, 4)*N_VIth(Y, 12);
   double r8=KC[8]*N_VIth(Y, 13);
   double r9=KC[9]*N_VIth(Y)*N_VIth(Y, 13);
   double r10=KC[10]*N_VIth(Y, 6);
   double r11=KC[11]*N_VIth(Y, 6)*N_VIth(Y, 15);
   double r12=KC[12]*N_VIth(Y, 7);
   double r13=KC[13]*N_VIth(Y, 13);
   double r14=KC[14]*N_VIth(Y, 13);
   double r15=KC[15]*N_VIth(Y, 7);
   double r16=KC[16]*N_VIth(Y, 7);
   double r17=KC[17]*N_VIth(Y, 7);
   double r18=KC[18]*N_VIth(Y, 13);
   double r19=KC[19]*N_VIth(Y, 14);
   double r20=KC[20]*N_VIth(Y, 8);
   double r21=KC[21]*N_VIth(Y, 4);
   double r22=KC[22]*N_VIth(Y);
   double r23=KC[23]*N_VIth(Y, 5);
   double r24=KC[24]*N_VIth(Y, 11);
   double r25=KC[25]*N_VIth(Y, 1)*N_VIth(Y, 5);
   double r26=KC[26]*N_VIth(Y, 15);
   N_VIth(Y2, 1)=1.000000*r0+1.000000*r1+−1.000000*r2;
   N_VIth(Y2, 2)=1.000000*r2+−1.000000*r3;
   N_VIth(Y2)=−1.000000*r9+1.000000*r10+1.000000*r13+1.000000*r15+−1.000000*r22;
   N_VIth(Y2, 4)=1.000000*r6+−1.000000*r7+1.000000*r8+−1.000000*r21;
   N_VIth(Y2, 5)=1.000000*r14+1.000000*r16+−1.000000*r23+−1.000000*r25+1.000000*r26;
   N_VIth(Y2, 6)=1.000000*r9+−1.000000*r10+−1.000000*r1+1.000000*r12;
   N_VIth(Y2, 7)=1.000000*r11+−1.000000*r12;
   N_VIth(Y2, 8)=1.000000*r3+1.000000*r 9+−1.000000*r20;
   N_VIth(Y2, 9)=−1.000000*r4+1.000000*r5;
   N_VIth(Y2, 10)=1.000000*r4+−1.000000*r5;
   N_VIth(Y2, 11)=1.000000*r17+1.000000*r18+−1.000000*r24;
   N_VIth(Y2, 12)=−1.000000*r7+1.000000*r8;
   N_VIth(Y2, 13)=1.000000*r7+−1.000000*r8+−1.000000*r9+1.000000*r10;
   N_VIth(Y2, 15)=1.000000*r25+−1.000000*r26;
}

### CODE EXAMPLE 2

### A Code Segment in MATLAB Implementing Differential Equations Representing Network Dynamics

r1=KC(1)*Y(1);
r2=KC(2)*Y(1)*Y(12);
r3=KC(3)*Y(2)*Y(12);
r4=KC(4)*Y(3);
r5=KC(5)*Y(9)*Y(10);
r6=KC(6)*Y(11);
r7=KC(7)*Y(10);
r8=KC(8)*Y(5)*Y(13);
r9=KC(9)*Y(14);
r10=KC(10)*Y(4)*Y(14);
r11=KC(11)*Y(7);
r12=KC(12)*Y(7)*Y(16);
r13=KC(13)*Y(8);
r14=KC(14)*Y(14);
r15=KC(15)*Y(14);
r16=KC(16)*Y(8);
r17=KC(17)*Y(8);
r18=KC(18)*Y(8);
r19=KC(19)*Y(14);
r20=KC(20)*Y(15);
r21=KC(21)*Y(9);
r22=KC(22)*Y(5);
r23=KC(23)*Y(4);
r24=KC(24)*Y(6);
r25=KC(25)*Y(12);
r26=KC(26)*Y(2)*Y(6);
r27=KC(27)*Y(16);
Y2=zeros(16, 1);
Y2(2)=1.000000*r1+1.000000*r2+−1.000000*r3;
Y2(3)=1.000000*r3+−1.000000*r4;
Y2(4)=−1.000000*r10+1.000000*r11+1.000000*r14+1.000000*r16+−1.000000*r23;
Y2(5)=1.000000*r7+−1.000000*r8+1.000000*r9+−1.000000*r22;
Y2(6)=1.000000*r15+1.000000*r17+−1.000000*r24+−1.000000*r26+1.000000*r27;
Y2(7)=1.000000*r10+−1.000000*r11+−1.000000*r12+1.000000*r13;
Y2(8)=1.000000*r12+−1.000000*r13;
Y2(9)=1.000000*r4+1.000000*r20+−1.000000*r21;
Y2(10)=−1.000000*r5+1.000000*r6;
Y2(11)=1.000000*r5+−1.000000*r6;
Y2(12)=1.000000*r18+1.000000*r19+−1.000000*r25;
Y2(13)=−1.000000*r8+1.000000*r9;
Y2(14)=1.000000*r8+−1.000000*r9+−1.000000*r10+1.000000*r11;
Y2(16)=1.000000*r26+−1.000000*r27;

### CODE EXAMPLE 3

### A Code Segment in C Implementing Trait Functions

A trait value may be defined for the simulated phenotype in the GP mapping system according to one embodiment. Below is an exemplary code segment that implements in C a number of trait functions defined for the molecular network of the yeast galactose genetic switch as well as a generic trait function based on root mean squared deviation from provided experimental measurements. See also, U.S. Provisional Application No. 60/499,955, filed Sep. 2, 2003 and U.S. Provisional Application No. 60/499,786 filed Sep. 2, 2003.

```
bool
Fitness::calculate (PathwayMatrix &pem, double &fitness, Matrix &mat) {
  fitness = 0.0;
  if(ff_{—} == 0) {
} else if(ff_{—} == 1) {
    int i, j;
    int ne = targets_.ncolumns( );
    int nm = targets_.nrows( );
    if(pem.simulation.numEnvironment( ) != ne) {
      pneDebug(“pem.simulation.numEnvironment( ) != ne”);
      return false;
    }
IMatrix inds(nm, 1);
for(i=0; i<nm; i++) {
  inds(i, 0) = pem.moleculeLookup(molecules_[i]);
  if(inds(i, 0) == −1) {
      pneDebug(QString(“Unable to locate molecule ”) + molecules_[i]);
      return false;
  }
}
mat.resize(nm, ne);
int oe = pem.curEnvironment( );
Matrix results;
for(i=0; i<ne; i++) {
  pem.setCurEnvironment(i);
  if(!run_simulation(pem, results)) {
      pem.setCurEnvironment(oe);
      return false;
  }
  for(j=0; j<nm; j++) {
      mat(j, i) = results(results.nrows( )−1, inds(j, 0));
  }
}
pem.setCurEnvironment(oe);
pneDebug(“Final results:”);
for(i=0; i<nm; i++) {
  QString str, str2;
  for(j=0; j<ne; j++) {
      if(j > 0) str += “\t”;
      str2.sprintf(“%g”, mat(i, j));
      str += str2;
  }
  pneDebug(“%s”, (const char*)str);
}
pneDebug(“”);
pneDebug(“Distance from target (results − targets):”);
for(i=0; i<nm; i++) {
  QString str, str2;
  for(j=0; j<ne; j++) {
      if(j > 0) str += “\t”;
      str2.sprintf(“%g”, mat(i, j) − targets_(i, j));
      str += str2;
  }
      pneDebug(“%s”, (const char*)str);
    }
    pneDebug(“”);
    for(i=0; i<nm; i++) {
      for(j=0; j<ne; j++) {
          double d = mat(i, j) − targets_(i, j);
          fitness += d * d;
      }
    }
    fitness = sqrt(fitness);
  } else if(ff_{—} >= 2) {
    Matrix results;
    if(!run_simulation(pem, results)) return false;
    switch(ff_) {
    case 2: fitness = glu6p_presence_fitness(pem, results); break;
    case 4: fitness = constant_glucose_fitness(pem, results); break;
    case 5: fitness = glu6p_glucose_fitness(pem, results); break;
    default:
      pneDebug(“Unknown fitness function %d\n”, ff_);
      return false;
    }
    if(fitness == −1) return false;
  }
  return true;
}
double
glu6p_presence_fitness(const PathwayMatrix &pem, const Matrix &results) {
  int gal_ind = pem.moleculeLookup(“GalExt”);
  int glu_ind = pem.moleculeLookup(“GluExt”);
  int glu6_ind = pem.moleculeLookup(“Glu-6P”);
  if(gal_ind == −1 ∥ glu_ind == −1 ∥ glu6_ind == −1) return −1.0;
  double gal_min = DBL_MAX, gal_max = −DBL_MAX;
  double glu_min = DBL_MAX, glu_max = −DBL_MAX;
  int n = results.nrows( ), i;
  for(i=0; i<n; i++) {
    if(results(i, gal_ind) < gal_min) gal_min = results(i, gal_ind);
    if(results(i, gal_ind) > gal_max) gal_max = results(i, gal_ind);
    if(results(i, glu_ind) < glu_min) glu_min = results(i, glu_ind);
    if(results(i, glu_ind) > glu_max) glu_max = results(i, glu_ind);
  }
  double sum_signedglu6 = 0.0, sum_glu6 = 0.0;
  for(i=0; i<n; i++) {
    bool gal = (results(i, gal_ind) − gal_min) / (gal_max − gal_min) > 0.5;
    bool glu = (results(i, glu_ind) − glu_min) / (glu_max − glu_min) > 0.5;
    int galandnotglu = (gal && !glu) ? 1 : −1;
    double glu6 = results(i, glu6_ind);
    double signedglu6 = glu6 * galandnotglu;
    sum_signedglu6 += signedglu6;
    sum_glu6 += glu6;
  }
  if(sum_glu6 == 0.0) return 0.0;
  return (1.0 + sum_signedglu6 / sum_glu6) / 2.0;
}
double
constant_glucose_fitness(const PathwayMatrix &pem, const Matrix &results) {
  int ind = pem.moleculeLookup(“Glu”);
  if(ind == −1) return −1.0;
  int i;
  double tstep = pem.simulation.timeStepSize( );
  int s1s = int(0/tstep+0.5);
  int s1e = int(50/tstep+0.5);
  int s2s = int(60/tstep+0.5);
  int s2e = int(80/tstep+0.5);
  if(s1s >= results.nrows( ) ∥
      s1e >= results.nrows( ) ∥
      s2s >= results.nrows( ) ∥
      s2e >= results.nrows( )) return −1.0;
  double sum_glu_env1 = 0.0;
  double sum_glu_env2 = 0.0;
  for(i=s1s; i<s1e; i++) {
    sum_glu_env1 += results(i, ind);
  }
  for(i=s2s; i<s2e; i++) {
    sum_glu_env2 += results(i, ind);
  }
  if(sum_glu_env2 == 0.0) return 0.0;
  double ratio = (sum_glu_env1 / (s1e − s1s)) / (sum_glu_env2 / (s2e − s2s));
  double fitness = 1.0 / (fabs(1.0 − ratio) + 1.0);
  double fitness2;
  if(ratio <= 1.0) {
    fitness2 = ratio;
  } else {
    fitness2 = 1.0 / ratio;
  }
  return fitness;
}
double
glu6p_glucose_fitness(const PathwayMatrix &pem, const Matrix &results) {
  double trait1 = glu6p_presence_fitness(pem, results);
  double trait2 = constant_glucose_fitness(pem, results);
  if(trait1 < 0.0 ∥ trait2 < 0.0) return −1.0;
  return trait1 * trait2;
}
```

It is to be understood that the description, specific examples and data, while indicating exemplary embodiments, are given by way of illustration and are not intended to limit the various embodiments of the present disclosure. All references cited herein for any reason, are specifically and entirely incorporated by reference. Various changes and modifications within the present disclosure will become apparent to the skilled artisan from the description and data contained herein, and thus are considered part of the various embodiments of this disclosure.

1. A computer system capable of deriving a genotype to phenotype map, wherein said genotype to phenotype map comprises a multiplicity of relations between one or more genotypes in different environments and one or more phenotypes, said system comprising:
(a) a molecular network model comprising at least one mathematical representation of interactions of a plurality of molecules, wherein one or more discrete parameter values are assigned to parameterized genetic loci based on allelic polymorphism, wherein one or more phenotypes are identified as observed phenotypes that are observed by experimentation under a multiplicity of conditions;
(b) a user interface capable of presenting said molecular network model and accepting user input; and
(c) an optimizer capable of executing an optimization strategy for obtaining a minimum of the distance between said observed phenotype and a simulated phenotype of the molecular network model thereby deriving said genotype to phenotype map, said simulated phenotype being computed by a trait function of the molecular network model under said multiplicity of conditions.

2. The computer system of claim 1, wherein said trait function derives the simulated phenotype by computing one of the variables of the model at one point in time.

3. The computer system of claim 1, wherein said trait function derives the simulated phenotype by integrating a simulated trajectory of said molecular network model.

4. The computer system of claim 1, wherein said trait function derives the simulated phenotype by taking one or more steady-state values of at least one of the state variables of said molecular network model.

5. The computer system of claim 1, wherein said trait function derives the simulated phenotype by calculating the time required for at least one of the state variables to reach a predetermined value.

6. The computer system of claim 1, wherein said trait function derives the simulated phenotype by taking the variance of time series of at least one of the state variables.

7. The computer system of claim 1, wherein said trait function derives the simulated phenotype by (i) summing the values of a first plurality of said state variables thereby deriving a first sum, (ii) summing the values of a second plurality of said state variables thereby deriving a second sum, and (iii) dividing said first sum by said second sum.

8. The computer system of claim 1, wherein said trait function derives the simulated phenotype by taking a Boolean value based on the one or more state variables of said molecular network model.

9. The computer system of claim 1, wherein said observed phenotype comprise at least one of a native trait and non-native trait.

10. The computer system of claim 1, wherein the state space of said mathematical representation is one of continuous, discrete, and any combination thereof.

11. The computer system of claim 1, wherein said mathematical representation is dynamic.

12. The computer system of claim 1, wherein the time evolution of said mathematical representation is one of deterministic, stochastic, and any combination thereof.

13. The computer system of claim 1, wherein the time evolution of said mathematical representation comprises at least one of differential equations or stochastic processes

14. The computer system of claim 1, wherein said optimization strategy comprises at least one of a local area optimization method, a global search method, and any combination thereof.

15. The computer system of claim 14, wherein said local area optimization method is one of the Newton method, simplex method, and the gradient descent method.

16. The computer system of claim 14, wherein said global search method is one of a genetic algorithm, differential evolution, simulated annealing, shifting search strategy, and random search.

17. The computer system of claim 1, wherein said optimization strategy applies at least one of linear programming and non-linear programming.

18. The computer system of claim 17, wherein said linear and non-linear programming is through at least one of deterministic and stochastic methods.

19. The computer system of claim 18, wherein said deterministic and stochastic methods are constrained or unconstrained.

20. The computer system of claim 1, wherein said molecular network model comprises a state space representing one or more molecule species, said state space comprises one or more dimensions, wherein each dimension of said state space comprises at least one of a variable and an environmental variable, wherein said variable represents one of said molecular species, wherein said environmental variable represents an environmental factor capable of altering other variables of said molecular network model.

21. The computer system of claim 20, wherein said environmental factor is a biotic environmental factor, representing a biological factor.

22. The computer system of claim 21, wherein said biotic environmental factor is one of insect pressure, virus pressure, fungus pressure, and disease pressure.

23. The computer system of claim 20, wherein said environmental factor is an abiotic environmental factor, representing a non-biological factor.

24. The computer system of claim 23, wherein said abiotic environmental factor is selected from the group consisting of temperature, light, pressure, pH, osmotic pressure, water availability, hormones, and chemical signals.

25. The computer system of claim 1, wherein experimental data is derived by experimentation from the group consisting of genomes, transcriptomes, proteomes, and metabolomes, wherein each of said genomes comprises a multiplicity of genes belonging to a species, wherein each of said transcriptomes comprises RNAs transcribed from a multiplicity of genes that populate a genome, wherein each of said proteoms comprises a multiplicity of proteins translated from a multiplicity of RNAs that populate a transcriptome, and wherein each of said metabolomes comprises a multiplicity of metabolic reactions among a multitude of biomolecules in the metabolism of a species.

26. The computer system of claim 25, wherein said species is selected form the group consisting of bacteria, viruses, yeast, mammal, and crop plants.

27. The computer system of claim 26, wherein said crop plants are selected from the group consisting of soybean, maize, canola, sorghum, wheat, rice, alfalfa, and canola.

28. The computer system of claim 26, wherein said mammal is a human

29. The computer system of claim 25, wherein said experimental data is generated using at least one of nucleotide and protein chips.

30. The computer system of claim 1, wherein computing is distributed among a master and one or more slaves, said master and slaves are connected via a network.

31. The computer system of claim 30, wherein said master is capable of (i) receiving data input from the user interface and distributing computing tasks to said one or more slaves, (ii) receiving intermediate computing results from said one or more slaves, (iii) compiling said intermediate computing results thereby deriving a final computing result, and (iv) sending said final computer result to the user interface for visualization by the user.

32. A computer data structure representing at least one of the genotypes and phenotypes in the molecular network model of the computer system of claim 1, said computer data structure capable of being stored in a computer readable medium.

33. A genotype to phenotype map derived in the computer system of claim 1, said genotype to phenotype map capable of being stored in a computer readable medium
